(19) United States
(12) Patent Application Publication
(10) Pub. No.: US 2022/0077932 A1
(43) Pub. Date: Mar. 10, 2022

(54) FIBER PUMP LASER SYSTEM AND METHOD FOR SUBMARINE OPTICAL REPEATER

(71) Applicant: IPG PHOTONICS CORPORATION, OXFORD, MA (US)

(72) Inventors: Ekatarina GOLOVCHENKO, Oxford, MA (US); Cristiano MORNATTA, Cerro Maggiore (IT); Stephen G. EVANGELIDES, Jr., Oxford, MA (US); Sergio Walter GRASSI, Cerro Maggiore (IT)

(73) Assignee: IPG PHOTONICS CORPORATION, OXFORD, MA (US)

(21) Appl. No.: 17/419,476

(22) PCT Filed: Dec. 20, 2019
(86) PCT No.: PCT/EP2019/086651

§ 371 Date: Jun. 29, 2021

(30) Foreign Application Priority Data
Dec. 31, 2018 (IT) 102018000021544

(51) Int. Cl. H04B 10/294; H01S 3/0941; H01S 3/067; H01S 3/094; H01S 3/16; H01S 3/10

(52) U.S. Cl. CPC H04B 10/294; H01S 3/09415; H01S 3/06741; H01S 3/06745; H01S 2301/04; H01S 3/1608; H01S 3/1618; H01S 3/10023; H01S 3/094065

(57) ABSTRACT

An optical communication system is disclosed. The optical communication system may include a first fiber pump laser system having a first single mode (SM) fiber output configured to output a first pump laser radiation, a second fiber pump laser system having a second SM fiber output configured to output a second pump laser radiation, at least one combiner-splitter element configured to combine the first pump laser radiation and the second pump laser radiation and to transmit N portions of pump laser radiation, and N doped fiber amplifiers, where N is at least four, each doped fiber amplifier configured to receive one portion of the N portions of pump laser radiation and an input optical signal to be amplified, amplify the input optical signal into an amplified optical signal, and to transmit the amplified optical signal.

### BACKGROUND

### Technical Field

The technical field relates generally to the use of fiber pump laser systems in submarine optical repeaters.

### Background Discussion

An optical amplifier or repeater is a device that amplifies an optical signal directly in the optical domain without converting the optical signal into a corresponding electrical signal. Optical amplifiers are widely used in the field of optical communications, including undersea fiber optic telecommunication systems. For long haul optical communications, e.g., greater than several hundred kilometers, the optical signal must be periodically amplified to compensate for the tendency of the data signal to attenuate.

One type of optical amplifier is a doped-fiber amplifier (i.e., an optical fiber amplifier) such as the erbium-doped fiber amplifier (EDFA). In operation, a signal to be amplified and a pump beam are multiplexed into the doped fiber. The pump beam excites the doping ions, and amplification of the signal is achieved by stimulated emission of photons from the excited dopant ions.

Undersea fiber optic cable is made up of multiple bidirectional fiber pairs. In conventional submarine fiber optic telecommunication transmission, each bidirectional fiber pair is serviced by two amplifiers pumped by a pair of pump lasers, as shown in the schematic diagram of FIG. 1. The output from each pump laser is combined and then split using a 3 dB directional coupler, and each output of the 3 dB coupler is used to pump one of the amplifiers. The pump light going into each amplifier is therefore a 50:50 combination of the output of pump laser A and pump laser B, which are single mode laser diodes. This configuration includes a redundancy scheme whereby a single pump laser failure will not cause the loss of signal through the amplifiers. In the instance where one diode fails, the pump power to each amplifier is reduced by half. The system can still function, but there is a penalty in that the amplifiers operate at a reduced gain, a higher Noise Figure (NF), and will exhibit gain tilt. Pump lasers used in high reliability applications such as submarine optical communication are operated at levels well below their maximum for purposes of prolonging their operating life. Therefore, when one laser diode fails, the output of the remaining working pump lasers cannot be increased to be 100% of their respective power capacity to compensate for the loss of the nonworking pump laser without also shortening their respective operating life. Therefore, the reduced gain, higher NF, and undesirable gain tilt will not be mitigated and will impair performance. The level of reliability required for the pump lasers is therefore very high for purposes of limiting the number of such impairments over the operating lifetime of the amplifier.

Continuous innovation in communication technologies enhances the capabilities of these systems in terms of the speed at which data can be transferred, as well as the overall amount of data being transferred. As these capabilities improve, the demand for additional communication capability also increases, which in turn fosters the need to provide additional capacity. For undersea fiber optic cable systems, this entails increasing the number of bidirectional pairs of optical fibers. However, electrical power for the entire cable must be transported along the cable, and therefore the ability to accommodate increasing numbers of pairs of optical fiber may be impeded by a limited amount of available power.

Furthermore, simply increasing the size of the repeater body would not only require procedural modifications for handling, integrating, and testing the larger repeater bodies, but would also be problematic for existing systems designed to transport, store, and deploy the repeater bodies. For example, increasing the length of the repeater body would result in the longer repeater body not properly contacting the surface of existing cable drums used to deploy the cable form the cable-laying vessel.

There is thus a continuing need for an undersea optical repeater that is capable of amplifying an increased number of fiber pairs using the same amount of available power and without exceeding the size of existing repeaters.

### SUMMARY

Aspects and embodiments are directed to a method and system for improving the reliability of single stage EDFA using fiber pump laser systems and enhancing the performance of an optical repeater that includes the EDFA.

In accordance with one aspect, an optical communication system is provided. The optical communication system includes a first fiber pump laser system having a first single mode (SM) fiber output configured to output a first pump laser radiation, a second fiber pump laser system having a second SM fiber output configured to output a second pump laser radiation, wherein each of the first and second fiber pump laser systems include at least two laser diodes, an active fiber optically coupled to the at least two laser diodes, and a multimode (MM) passive fiber disposed between the at least two laser diodes and the active fiber, at least one combiner-splitter element configured to combine the first pump laser radiation and the second pump laser radiation and to transmit N portions of pump laser radiation, and N doped fiber amplifiers, where N is at least four and each doped fiber amplifier is configured to receive one portion of the N portions of pump laser radiation and an input optical signal to be amplified, amplify the input optical signal into an amplified optical signal, and transmit the amplified optical signal.

In one example, each laser diode is configured to provide about 1 Watt of power. In another example, the optical communication system further includes a controller configured to control the at least two laser diodes such that each laser diode provides ⅓ to ½ Watt of power. In another example, each of the first and second fiber pump laser systems is configured to provide at least 2 Watts of output power. In yet another example, each of the first and second fiber pump laser systems is configured to operate such that each provides less than 1 Watt of output power.

In one example, each of the first and second fiber pump laser systems further comprises an input passive fiber disposed between the MM passive fiber and the active fiber, the MM passive fiber having a tapered free end with a mode field diameter (MFD) that matches that of an input end of the input passive fiber. In another example, each of the first and second fiber pump laser systems further includes an output SM passive fiber coupled to an output end of the active fiber and configured to output the respective first and second pump radiation. In another example, the MM passive fiber, the input passive fiber, and the active fiber are constructed from photonic crystal fiber.

In one example, the first fiber pump laser system is configured to output the first pump radiation at a wavelength of about 978 nm and the second fiber pump laser system is configured to output the second pump laser radiation at a wavelength of about 983 nm. In another example, each of the first and second fiber pump laser systems includes N laser diodes.

In one example, the optical communication system further includes N wavelength division multiplexing (WDM) couplers, each WDM coupler positioned between the at least one combiner-splitter element and a doped fiber amplifier of the N doped fiber amplifiers and configured to couple the input optical signal and the one portion of the N portions of pump laser radiation into an output that is provided to a doped fiber amplifier of the N doped fiber amplifiers.

According to another aspect, a method for providing a fiber laser pump signal in an optical communication system is provided. The method includes providing first and second fiber pump laser systems, each of the first and second fiber pump laser systems including at least two laser diodes, an active fiber optically coupled to the at least two laser diodes, and a multimode (MM) passive fiber disposed between the at least two laser diodes and the active fiber, generating single mode (SM) first and second pump laser radiation from the respective first and second fiber pump laser systems, combining the SM first and second pump laser radiation to form a combined pump laser radiation, splitting the combined pump laser radiation to form N portions of pump laser radiation, where N is at least four, and directing an input optical signal to be amplified and each portion of pump laser radiation to a doped fiber amplifier, the doped fiber amplifier configured to receive the input optical signal and the portion of pump laser radiation and to amplify the input optical signal into an amplified optical signal.

In one example, the method further includes controlling the at least two laser diodes such that each laser diode provides ⅓ to ½ Watt of power. In another example, the method further includes controlling each of the first and second fiber pump laser systems to provide less than 1 Watt of output power.

In one example, the method further includes providing the MM passive fiber with a tapered free end with a mode field diameter (MFD) that matches that of an input end of an input passive fiber having an output end spliced to the active fiber.

In another example, the method further includes providing the MM passive fiber, the active fiber, and the input passive fiber as photonic crystal fibers.

In another example, the method further includes providing at least one combiner-splitter element configured to perform the combining and the splitting, the method further comprising coupling the SM first and second pump laser radiation generated by the respective first and second fiber pump laser systems to the at least one combiner-splitter.

In accordance with another aspect, a submersible fiber pump laser system for an erbium doped amplifier configured to amplify input optical signals in a fiber optic undersea communication system is provided. The submersible fiber pump laser system includes a multimode (MM) pig-tailed diode laser module that includes N laser diodes enclosed in a housing, where N is at least two and the N laser diodes are operative to generate pump light at a first wavelength, and an output MM fiber optically coupled to the N laser diodes and configured as a photonics crystal fiber with a tapered free end, and a ytterbium-doped fiber amplifier configured to amplify the pump light and having a passive input end and a passive output end, the passive input end spliced to the tapered free end of the output MM fiber, the ytterbium-doped fiber amplifier operative to generate amplified pump light at a second wavelength that is longer than the first wavelength and is output from the passive output end.

In one example, an optical repeater containing at least four of the submersible fiber pump laser systems is provided. In a further example, two of the four submersible fiber pump laser systems are configured to pump four doped fiber amplifiers optically coupled to input optical signals propagating in a first direction and the other two of the four fiber pump laser systems are configured to pump four doped fiber amplifiers optically coupled to input optical signals propagating in a second direction that is opposite the first direction.

In accordance with another aspect, an optical repeater is provided. The optical repeater includes an amplifier tray assembly having a surface configured with at least one recess dimensioned to receive a gain block module, a plurality of fiber pump laser systems, each fiber pump laser system including a multimode (MM) pig-tailed diode laser module having N laser diodes, where N is at least two and the N laser diodes are operative to generate pump light at a first wavelength, and an output MM fiber optically coupled to the N laser diodes and configured as a photonics crystal fiber with a tapered free end, and a ytterbium-doped fiber amplifier configured to amplify the pump light and having a passive input end and a passive output end, the passive input end spliced to the tapered free end of the output MM fiber, the amplifier operative to generate amplified pump light at a second wavelength that is longer than the first wavelength and is output from the passive output end, and a laser tray assembly having a surface configured with a plurality of recesses, each recess dimensioned to receive a fiber pump laser system of the plurality of fiber pump laser systems.

In one example, the optical repeater further includes at least one gain block module, that at last one gain block module including a plurality of gain block assemblies, each gain block assembly including an input, an output, and an erbium (Er) doped fiber disposed between the input and the output, the input optically coupled to the passive output end of at least one fiber pump laser system. In another example, the passive output end of the ytterbium-doped fiber amplifier is included in a SM delivery fiber and the surface of the laser tray assembly includes a plurality of channels dimensioned to receive at least one SM delivery fiber.

In one example, the optical repeater further includes a fiber guide assembly attached at opposing end portions of the amplifier tray assembly, each fiber guide assembly including guide channels configured to couple to at least one of the plurality of channels and to the input of at least one gain block assembly of the plurality of gain block assemblies.

In another example, the optical repeater further includes a thermally conductive ceramic member disposed between the amplifier tray assembly and the laser tray assembly.

In another example, the optical repeater further includes a printed circuit board having opposing outer faces and configured such that a plurality of photodetector diodes are disposed on one of the opposing outer faces and one of the opposing outer faces is disposed on the surface of the laser tray assembly. In a further example, the amplifier tray assembly, the laser tray assembly, the plurality of fiber pump laser systems, the at least one gain block module, the fiber guide assembly, the thermally conductive ceramic member, and the printed circuit board form at least a portion of an erbium doped fiber amplifier (EDFA) module, and the optical repeater is configured to include three EDFA modules arranged in a triangular configuration. In yet a further example, each EDFA module includes four fiber pump laser systems and a gain block module having eight gain block assemblies, the EDFA module configured such that two of the four fiber pump laser systems pump four of the eight gain block assemblies and the other two of the four fiber pump laser systems pump the other four of the eight gain block assemblies.

In one example, the optical repeater includes at least one input configured to accommodate at least 12 fiber pairs of input signal optical fiber.

In one example, the optical repeater of has a gain of at least 14 dB and an output power of +17 dB.

Still other aspects, embodiments, and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Embodiments disclosed herein may be combined with other embodiments, and references to “an embodiment,” “an example,” “some embodiments,” “some examples,” “an alternate embodiment,” “various embodiments,” “one embodiment,” “at least one embodiment,” “this and other embodiments,” “certain embodiments,” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a schematic representation of a conventional pump arrangement for providing pump power redundancy to optical fiber amplifiers;

FIG. 2A is a schematic representation of one example of an optical communication system having one configuration of combiner-splitter elements in accordance with one or more aspects of the invention;

FIG. 2B is the optical communication system of FIG. 2A with a different configuration for the combiner-splitter element in accordance with one or more aspects of the invention;

FIG. 3 is a schematic representation of another example of an optical communication system in accordance with one or more aspects of the invention;

FIG. 4 is a schematic representation of yet another example of an optical communication system in accordance with one or more aspects of the invention;

FIG. 5 is an optical schematic of a portion of the optical communication system of FIG. 2A;

FIG. 6 is an optical schematic of one example of a fiber pump laser system in accordance with aspects of the invention;

FIG. 7A is one schematic representation of fiber portions of the fiber pump laser system in accordance with aspects of the invention;

FIG. 7B is another schematic representation of fiber portions of the fiber pump laser system in accordance with aspects of the invention;

FIG. 8A is a cross-sectional schematic representation of one example of a photonic crystal fiber in accordance with aspects of the invention;

FIG. 8B is a cross-sectional schematic representation of another example of a photonic crystal fiber in accordance with aspects of the invention;

FIG. 9 is a schematic representation of a refractive index profile across the diameter of the photonic crystal fiber of FIG. 8;

FIG. 10A is a perspective view of a pair of gain block modules and one side of a tray assembly used in a first example of an optical repeater in accordance with aspects of the invention;

FIG. 10B is a perspective view of the pair of gain block modules of FIG. 10A inserted into the tray assembly;

FIG. 11 is a perspective view of a printed circuit board used in the first example of the optical repeater in accordance with aspects of the invention;

FIG. 12 is a perspective view of the second side of the tray assembly of FIG. 10A;

FIG. 13 is a perspective view of the printed circuit board of FIG. 11 positioned with the tray assembly of FIG. 12;

FIG. 14A is a perspective view of a fiber guide assembly positioned with the tray assembly of FIG. 10B;

FIG. 14B is a perspective view of a ceramic plate and the fiber guide assembly positioned with the tray assembly of FIG. 13;

FIG. 14C is a perspective view of the ceramic plate and fiber guide assembly of FIG. 14A;

FIG. 15 is a perspective view of a portion of the first example of the optical repeater in accordance with aspects of the invention;

FIG. 16 is a cross-sectional view of the first example of the optical repeater in accordance with aspects of the invention;

FIG. 17 is a perspective view of the first example of the optical repeater in accordance with aspects of the invention;

FIG. 18 is a perspective view of the optical repeater of FIG. 17 in combination with one bulkhead and an organizer endplate;

FIG. 19 is a perspective view of a fully assembled first example of the optical repeater positioned within a circular sleeve in accordance with aspects of the invention;

FIG. 20 illustrates example operations for an optical communication system with enhanced reliability in accordance with aspects of the invention;

FIG. 21A is a perspective view of a gain block module and one side of a tray assembly used in a second example of an optical repeater in accordance with aspects of the invention;

FIG. 21B is a perspective view of the gain block module of FIG. 21A inserted into the tray assembly;

FIG. 22 is a perspective view of a printed circuit board used in the second example of the optical repeater in accordance with aspects of the invention;

FIG. 23 is a perspective view of the second side of the tray assembly of FIG. 21A with the printed circuit board of FIG. 22;

FIG. 24 is a partially cutaway perspective view of the tray assembly used in the second example of the optical repeater;

FIG. 25A is a perspective view of one side of a portion of the second example of the optical repeater;

FIG. 25B is a perspective view of the opposite side of the portion of the optical repeater of FIG. 25A;

FIG. 26A is a perspective view from one side of the second example of the optical repeater;

FIG. 26B is a perspective view of the optical repeater of FIG. 27A taken from another side; and

FIG. 27 is a perspective view of one end of the second example of the optical repeater.

### DETAILED DESCRIPTION

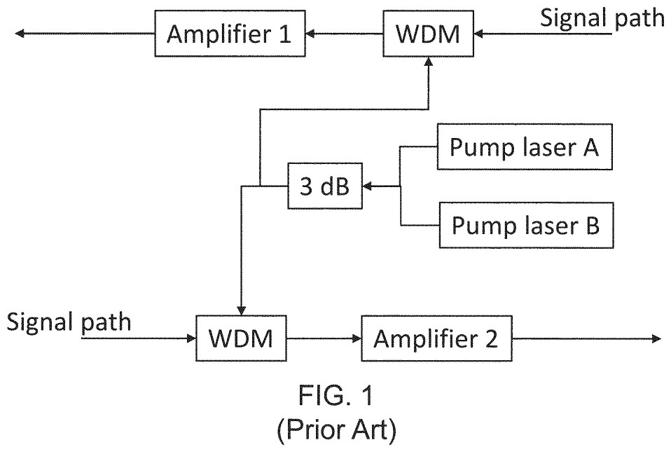

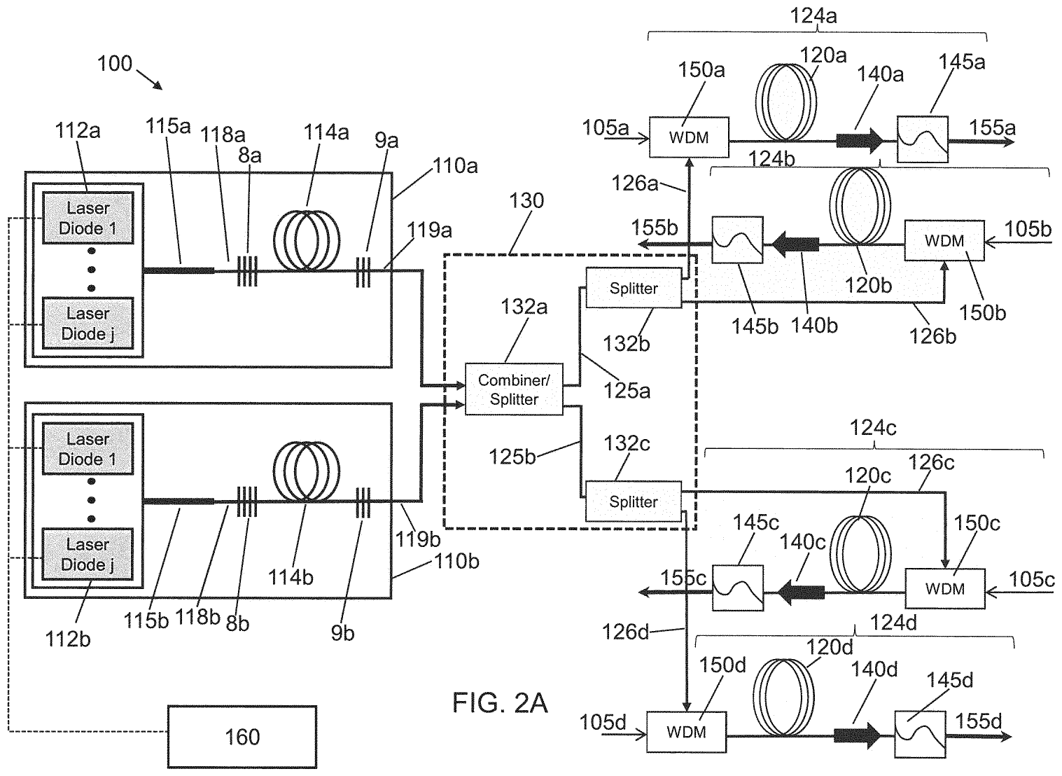

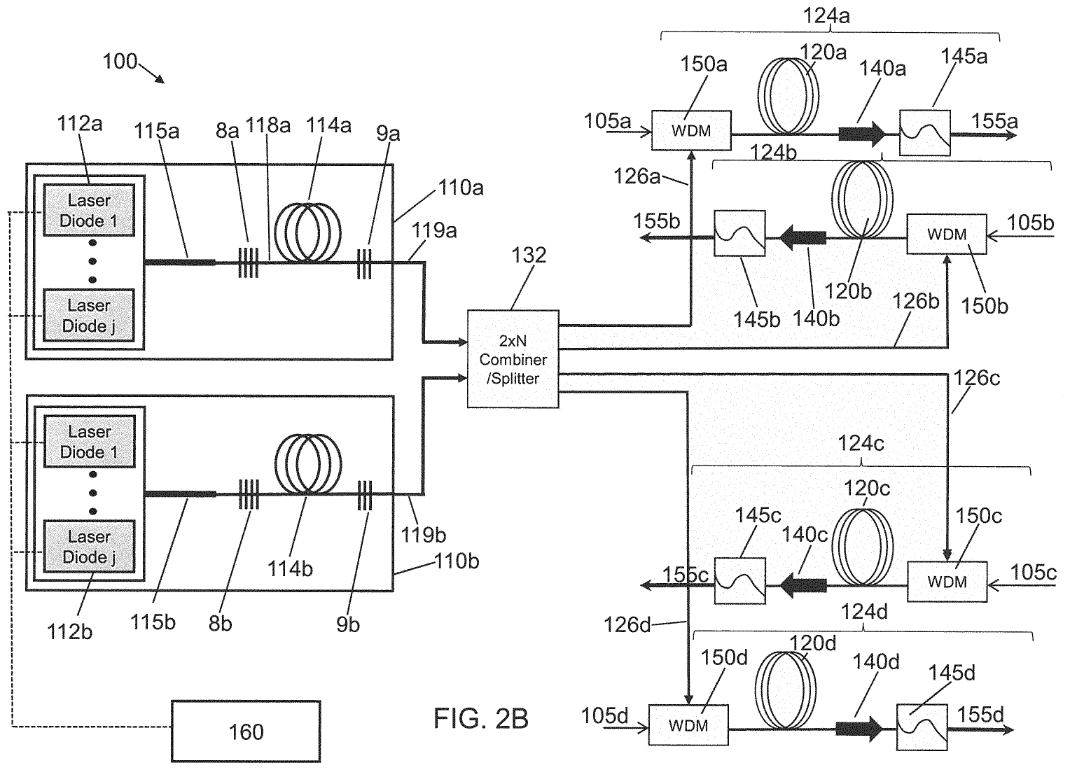

The systems and methods disclosed herein are suitable for long distance transmission of optical signals, and are configured to supply pump power used to amplify an input optical signal. The pump power is supplied by fiber pump laser systems that include laser diode pump sources and a fiber resonator (active fiber). Multiple laser diode pump sources can be multiplexed together to the fiber resonator, which allows for the number of laser diodes to be increased to any desired number. In contrast to the system shown in FIG. 1 where two laser diodes pump two amplifiers, the fiber pump laser systems described herein increase the reliability (and redundancy) of the optical communication system in that the loss of one laser diode results in less loss of pump power to the amplifier. For instance, instead of each bidirectional fiber pair having its own pair of pumps, the pumping schemes presented herein allow for the pumps to pump multiple bidirectional (or unidirectional) pairs. According to one example, the disclosed systems can provide two fiber pump systems capable of pumping four amplifiers (as shown in FIGS. 2A and 2B and discussed further below). For a proposed system according to the teachings of this disclosure which has two fiber pump laser systems that are each configured with N/2 diodes that pump N amplifiers, the failure of one diode results in a loss of 1/N pump power to each amplifier. In addition, in order to restore full pump power, the remaining pumps have to increase their pump power by 1/(N−1)%. As N gets larger, the impact of a single failure diminishes and the required amount of power from each remaining laser diode needed to restore full pump power diminishes. This allows for the remaining working pump laser diodes to be operated at less than 100% of their respective power capacity, which does not compromise their operating lifetime.

The proposed pumping scheme is easily scalable so that as higher fiber counts are added, the pump power can be increased without dramatically impacting the footprint of the fiber pump or repeater. This means that the size of the repeater body does not have to be increased as more amplifying capacity is added, and can therefore be used in existing cable drums and other components used by cable-laying vessels configured to deploy the cable.

An optical repeater that uses the fiber pump laser systems disclosed herein is capable of amplifying more fiber pairs using the same amount of available power in comparison to existing undersea repeaters. In addition, the disclosed optical repeater has dimensions that do not exceed the size of existing undersea repeaters.

One example of an optical communication system in accordance with aspects of the invention is shown generally at 100 in the schematic representation depicted in FIG. 2A. The system 100 includes at least one fiber pump laser system 110, and the example shown in FIG. 2A includes two fiber pump laser systems indicated at 110a and 110b, although it is to be appreciated that systems having more than two fiber pump laser systems are also within the scope of this disclosure. The system 100 also includes at least one combiner-splitter element 132, which is configured in the example of FIG. 2A as an array of combiner-splitter elements 130 that includes combiner-splitter elements 132a, 132b, and 132c. System 100 also includes N doped fiber amplifiers 120, in which N=4 and are depicted as 120a, 120b, 120c, and 120c for the example shown in FIG. 2A. As with the number of fiber pump laser systems, it is to be appreciated that the number of doped fiber amplifiers can be greater than 4 depending on the configuration of the system.

Each of the first and second fiber pump laser systems 110a and 110b are configured to have respective single mode (SM) fiber outputs 119a and 119b that each output respective first and second pump laser radiation. As used herein, the term “mode” refers to a guided mode, and a single mode fiber is an optical fiber primarily designed to support a single mode, whereas a multimode optical fiber is primarily designed to support the fundamental mode and at least one higher-order mode. As used herein, the terms “single mode” and “multimode” refer to transverse modes.

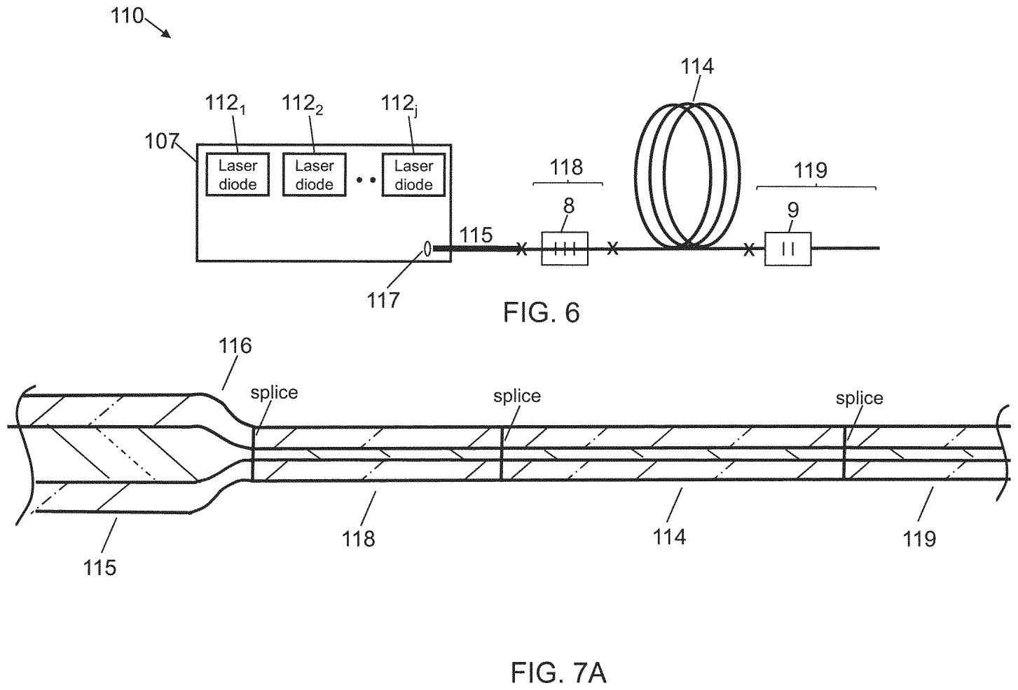

An optical schematic of one example of a fiber pump laser system 110 is shown in FIG. 6. The configuration shown in FIG. 6 illustrates an end pumping configuration but a side pumping configuration is also within the scope of this disclosure. The fiber pump laser system 110 comprises a laser diode module 107 disposed in a housing that includes a source of radiation having at least two laser diodes 112₁ and 112₂, and may include up to j laser diodes (112ⱼ). The number of laser diodes 112 may depend on one or more factors, including the particular application (e.g., distance to be covered by the undersea repeater), the power capacity output of the laser diode, and the desired redundancy level. According to one embodiment, the fiber pump laser system 110 includes two laser diodes. In other embodiments, the fiber pump laser system 110 has more than two laser diodes. According to some embodiments, the fiber pump laser system 110 may include N/2 laser diodes, where N has a value of at least four, and is divisible by two. As will be appreciated, the number of laser diodes can be scaled to correspond to a desired pump power.

Each laser diode 112₁ through 112ⱼ outputs light which is focused via an objective lens 117 to the upstream end of the diode module output fiber 115. In accordance with various aspects, the laser diode module 107 in combination with the diode module output fiber 115 is referred to as a multimode (MM) pig-tailed diode laser module. The diode module output fiber 115 guides light emitted from the diode module 107 toward the input passive fiber 118 that includes high reflectivity mirror 8, which is part of the gain block that also includes active fiber 114 and partial reflectivity mirror 9 written into output passive fiber 119.

According to one embodiment, each laser diode 112 may be configured to provide about 1 Watt of power (i.e., the maximum power). However, during actual operation, the laser diode 112 may be configured to output less than the maximum power, such as ⅓ to ½ Watt of power. For instance, a controller 160 (as shown in FIG. 2A) may control the laser diode 112 to operate at less than 100% of the maximum possible output power, which as explained above, preserves the operating life of the laser diode. Each laser diode 112 is configured to emit multimode (MM) laser radiation at a wavelength that is capable of being absorbed by the active dopant in the core of active fiber 114. In instances where ytterbium is used to dope the core of active fiber 114, the laser diodes 112 may emit light within a wavelength range of 910 nm to 950 nm, and according to some embodiments the laser diodes 112 emit light within a wavelength range of 915 to 925 nm.

The controller 160 may include one or more processors with feedback and control circuitry to measure or otherwise ascertain the output power of each laser diodes 112 and provide feedback control of the output of each laser diode. The controller 160 is therefore capable of determining when a laser diode fails and can therefore respond accordingly (e.g., increasing the output of the remaining laser diodes).

The diode module output fiber 115 of the fiber pump laser system 110 is disposed between the laser diodes 112 and the input passive fiber 118 of the gain block that also includes active fiber 114. The active fiber 114 of the fiber pump laser system 110 is formed from a fiber section having a core that is doped with ions of ytterbium (Yb), which in some instances may be co-doped with erbium (Er). The fiber pump laser system 110 also includes input 118 and output 119 passive optical fibers disposed on either end of the active fiber 114 that each integrate Bragg reflection gratings 8 and 9, respectively. The reflection gratings 8 and 9 function as laser resonant cavity mirrors, as will be appreciated by those skilled in the art, and define the output wavelength of the fiber pump laser system 110. Fiber Bragg grating 8 is configured as a High Reflection Fiber Bragg Grating (HR FBG), and Fiber Bragg grating 9 is configured as Partial Reflection Fiber Bragg Grating (PR FBG).

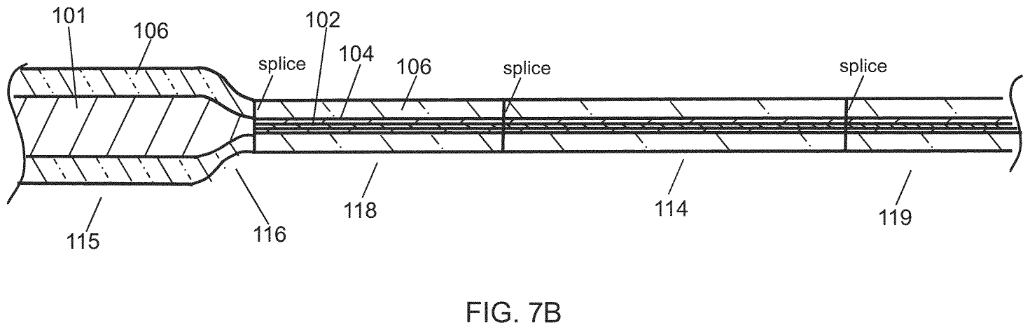

According to one embodiment, diode module output fiber 115 is configured as a multimode (MM) passive fiber. The output beam from the objective lens 117 of the laser diode module 107 is composed of the spatially multiplexed individual light beams from laser diodes 112₁ through 112ⱼ. This MM laser diode output radiation is launched into the upstream (or input) end of MM passive fiber 115, which has a cladding diameter sized to substantially match the transverse and lateral width of the output beam from the MM laser diodes. As shown in FIG. 7A, MM passive fiber 115 is configured with tapered free end 116 (discussed further below) that has a smaller diameter than the diameter of the upstream or input end. The output diameter of the adiabatically tapered free end 116 of MM passive fiber 115 is configured such that the mode field diameter (MFD) matches the cross section of the cladding of input passive fiber 118 spliced to the output end of MM passive fiber 115.

As an overall structure, the core and cladding of MM passive fiber 115 is configured as a single bottleneck-shaped cross-section when viewed along the longitudinal fiber axis. The cross-section of the respective core and cladding includes uniformly dimensioned input end region and mid-region, and a narrowly-dimensioned output end region (i.e., at the end of the taper). The core of the uniformly dimensioned input and mid-region has a diameter that is larger than the core of the output end region. As shown in FIG. 7A, a frustoconical output region bridges the mid and output regions. The cladding of MM passive fiber 115 may have a cross-section complementary to that of the core (as shown in FIG. 7A) or may have a uniform cross-section. According to certain aspects, the end region of the bottleneck shape may be substantially shorter than the mid region and dimensioned so as to prevent the manifestation of nonlinear effects.

The input (upstream) end of passive input fiber 118 is butt-spliced to the tapered free end 116 of MM passive fiber 115 and the output (downstream) end of passive input fiber 118 is butt-spliced to active fiber 114, as shown in FIG. 7A. Input passive fiber 118 is configured with a SM core and a MM cladding, with the HR FBG 8 written into the SM core. Active fiber 114 (also referred to as an active amplifying fiber) is configured with a SM core and a MM cladding. MM radiation propagated through MM passive fiber 115 passes through the MM cladding of passive input fiber 118 and is propagated through the splice region to active fiber 114, where MM cladding of active fiber 114 guides the MM pump radiation, and the SM core absorbs the MM pump radiation along the length of the active fiber 114 as understood by those skilled in the art. Output passive fiber 119 is configured with a SM core and may also be referred to as a SM delivery or output fiber of the fiber pump laser system 110. SM output fiber 119 is butt-spliced to the output end of active fiber 114. Residual MM pump radiation propagating in the MM cladding of active fiber 114 is dissipated into the splice region between active fiber 114 and SM output fiber 119, while SM pump radiation propagates through the splice region between these fibers such that SM radiation is output from the fiber pump laser system 110.

The SM cores of input passive fiber 118, active fiber 114, and output passive fiber 119 are configured to optically match one another for purposes of minimizing optical losses. Passive fibers 118 and 119, and active fiber 114 are configured with respective MFDs which substantially match one another. The core of active fiber 114 is dimensioned so that a MFD of SM light supported by input passive fiber 118 substantially matches that of the active fiber 114. Similarly, the MFD of active fiber 114 substantially matches that of SM output fiber 119 such that light propagating through a butt-splice region between fibers 114 and 119 does not lose any substantial power.

The geometries, i.e., the cross-sections of the core and cladding of input passive fiber 118, active fiber 114, and output passive fiber 119 are also configured to match one another. As shown in FIG. 7A, the diameter of the core and cladding of active fiber 114 are matched to that of the respective diameters of the cores and claddings of passive input and output fibers 118 and 119. Butt-splicing is performed such that the SM cores of fibers 118 and 119 are aligned to the SM core of active fiber 114. As also shown in FIG. 7A, the diameters of the core and cladding of MM passive fiber 115 are tapered via the bottleneck-shape to match the respective diameters of the core and cladding of passive SM fiber 118. The input and output ends of active fiber 114 are therefore configured to geometrically and optically (MFD) match that of the output end of passive input fiber 118 and the input end of SM output fiber 119.

Certain fibers used in the fiber pump laser system 110 are configured as a photonic crystal fiber (PCF). In particular, MM passive fiber 115, input passive SM fiber 118, and active fiber 114 are configured as PCFs.

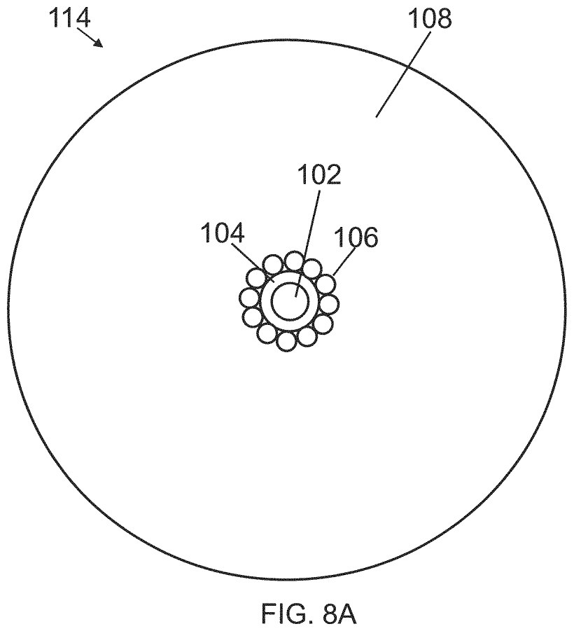

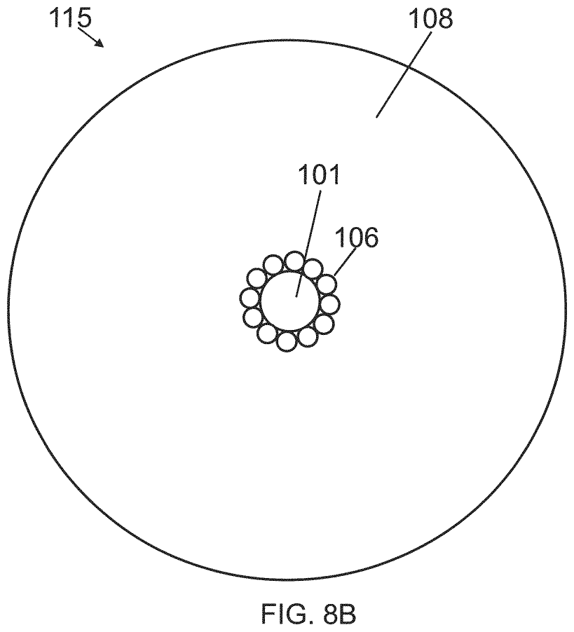

According to one embodiment, the PCF fiber is configured as a double-clad PCF, one example cross-section of which is shown in FIG. 8A. A first cladding 104 surrounds the core 102, and a second (air hole) cladding 106 surrounds the first cladding 104. In some embodiments, the core 102 is made of silica phosphate (SiO₂—P₂O₅), and for active fiber 114, the core is doped with ytterbium, as discussed previously. In other embodiments, the core is an aluminosilicate material. The first cladding 104 comprises quartz that is doped with one or more refractive index influencing materials, such as germanium (Ge), phosphorus (P), fluorine (F) etc., as well as oxides of these elements. In some embodiments, one or more refractive index reducing materials (e.g., Ge and/or P and/or their oxides) are used as dopant materials to the quartz (SiO₂) of the first cladding 104. The doping is performed such that the refractive index of first cladding 104 is lower than the refractive index of the core 102. A plurality of air holes form the second cladding 106. The air holes are configured as longitudinally aligned air-filled capillaries, which extend parallel to the core 102. An outer jacket 108 of polymer material surrounds the air holes of second cladding 106. The cross-section shown in FIG. 8A is exemplary of input passive fiber 118 and active fiber 119.

A cross-section of the PCF fiber forming MM passive fiber 115 is shown in FIG. 8B. The MM core 101 is surrounded by air hole cladding 106, which is itself surrounded by the outer jacket 108.

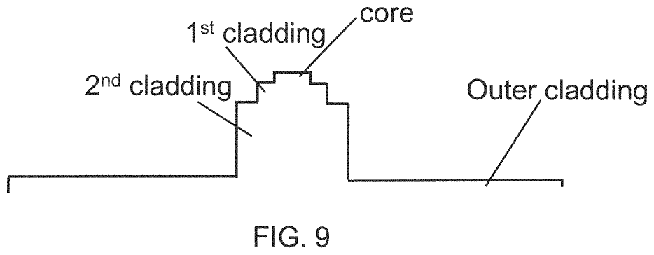

A refractive index profile (idealized) across the diameter of active PCF 114 (and passive input fiber 118) is shown in FIG. 9. The fiber has a pedestal refractive index profile in that the first cladding 104 has a refractive index that is lower than the core region 102, and the second (air hole) cladding 106 has a refractive index that is lower than both the first cladding 104 and the core 102. The refractive index therefore progressively decreases in a step-wise fashion from the core out to the first and second claddings 102 and 104.

The optical schematic shown in FIG. 7B is one example configuration for when PCF fibers are used in the fiber pump laser system 110. MM light from laser diodes 112 is launched into the core 101 and cladding 106 of passive fiber 115. This MM laser diode pump light is then guided by the cladding of MM passive fiber 115 into the cladding of input passive fiber 118. As shown in FIG. 7B, the MM passive fiber has a tapered free end 116, the output of which is configured such that the mode field diameter (MFD) matches that of input passive fiber 118 spliced to the output end of MM passive fiber 115. This MM pump radiation is then guided to active fiber 114, where is it absorbed by the SM doped core. Passive output fiber 119 is not configured as a PCF and therefore residual MM radiation guided from active fiber 114 is terminated at the input end of passive output fiber 119 and dissipated into the splice between active fiber 114 and passive output fiber 119. SM pump radiation that propagates through the fiber pump laser system 110 via SM passive output fiber 119 is generated as a Fabry Perot resonant cavity created by the HR FBG 8 written into passive input fiber 118, active fiber 114, and the PR FBG 9 written into SM passive output fiber 119.

The use of PCF for the active fiber 114 allows the length of the active fiber 114 to be shorter than systems that use side pumping configurations or end-pumping configurations without the use of PCF. Besides offering a smaller size, the reduced length of the gain medium increases the threshold for undesirable nonlinear effects.

The fiber pump SM radiation emitted from the fiber pump laser system 110 via passive output fiber 119 may be at least 2 Watts of power. However, during operation the fiber pump laser system 110 may provide less than 1 Watt of output power. One or more controllers 160 (e.g., FIG. 2A) controls the power output of the fiber pump laser system 110. According to one embodiment, the fiber pump laser system 110 has a wall plug efficiency of about 20% in the 400 mW to 800 mW output power range, and with higher drive currents, this value can be increased further.

The configuration, e.g., the presence of the fiber laser in the pump of fiber pump laser system 110 allows for higher power pump light at the pumping wavelength to be coupled to the core of doped fiber amplifier 120 (EDFA) as compared to laser diodes alone supplying the pump power. The MM fiber 115 has the ability to guide pump light having a higher optical power, which is then propagated as high intensity light into the core of the active fiber 114; thereby increasing the power supplied by the fiber pump laser system 110. End pumping the core of doped fiber amplifier 120 with this higher pump power facilitates more effective absorption by the dopant ions of the amplifier, and thus greater amplification capacity (as compared to laser diodes alone). More amplifiers, and subsequently more (input) fiber pairs can therefore be accommodated without changing the input power required by the pump.

The optical communication system 100 also includes at least one combiner-splitter element 132 that is configured as a fused fiber optic coupler that functions to combine the pump laser radiation transmitted by fiber pump laser systems 110a and 110b and split the combined optical signal into desired portions. The example shown in FIG. 2A has an array of combiner-splitter elements 130 that includes a first combiner-splitter element 132a that is optically coupled to the output fiber pump radiation 119a of fiber pump laser system 110a and the output fiber pump radiation 119b of fiber pump laser system 110b. The first combiner-splitter element 132a combines the output fiber pump radiations 119a and 119b (optical signals) and outputs a first portion 125a and a second portion 125b of pump laser radiation. In some embodiments each combiner-splitter element 132 is configured as a 50/50 coupler, as known in the art. According to other embodiments, one or more of the combiner-splitters 132 may be configured to split the pump laser radiation into unequal portions.

First and second portions of pump laser radiation 125a and 125b may be introduced to a pair of combiner-splitter elements 132b and 132c that are positioned downstream from combiner-splitter element 132a. In the example shown in FIG. 2A, combiner-splitter element 132b is configured as a splitter that receives first portion of pump laser radiation 125a and splits it to output a third portion of pump laser radiation 126a and a fourth portion of pump laser radiation 126b. Likewise, combiner-splitter element 132c is also configured as a splitter that receives the second portion of pump laser radiation 125b which is split into fifth and sixth portions of pump laser radiation 126c and 126d respectively. Each of third, fourth, fifth, and sixth pump laser radiation portions 126a, 126b, 126c, and 126d are respectively used to pump one of the N doped fiber amplifiers 120 (in this example, 120a, 120b, 120c, and 120d, respectively) of the optical communication system 100.

Turning now to FIG. 2B, the optical system 100 is identical to that shown in FIG. 2A, except that according to this example, the at least one combiner-splitter element 132 is constructed in a 2×N configuration. The 2×N combiner-splitter is optically coupled to the output fiber pump radiation 119a of fiber pump laser system 110a and the output fiber pump radiation 119b of fiber pump laser system 110b and outputs N portions (which in this example is 4) of pump laser radiation 126a, 126b, 126c, and 126d, which are then used to pump doped amplifiers 120a, 120b, 120c, and 120d respectively.

Each of fiber pump laser systems 110a and 110b output pump radiation at a wavelength suitable for pumping doped fiber amplifier 120, which is typically doped with erbium. The fiber pump laser systems 110a and 110b may each therefore emit pump radiation in a wavelength band centered at about 980 nm. According to at least one embodiment, the fiber pump laser system 110 emits light at a wavelength in the range of 975 nm to 985 nm. In one embodiment, the fiber pump laser system 110 emits light at a wavelength in the range of 976 nm to 983 nm.

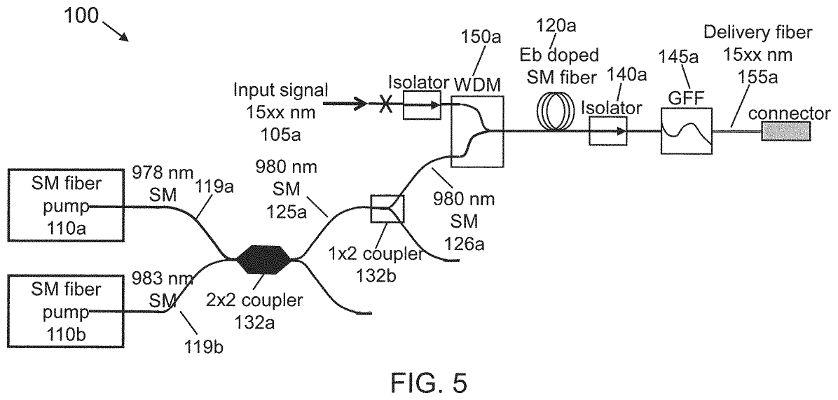

In accordance with some embodiments, fiber pump laser systems 110a and 110b may be configured to output pump radiation at different wavelengths. For example, fiber pump laser system 110a may be configured to output pump radiation at a wavelength of about 978 nm and fiber pump laser system 110b may be configured to output pump radiation at a wavelength of about 983 nm. Depending on the configuration, once combined by the at least one combiner-splitter element 132, the portions of pump laser radiation have a wavelength of about 980 nm. This is also represented in the optical schematic of FIG. 5, which is a partial schematic.

System 100 also includes N wavelength selective couplers 150, with the example shown in FIGS. 2A and 2B including four N wavelength selective couplers 150a, 150b, 150c, and 150d. Each wavelength selective coupler 150 is positioned between the at least one combiner-splitter element 132 and a doped fiber amplifier 120 and is configured to couple the input optical signal 105 that is to be amplified and the pump laser radiation 126 into an output that is provided to the doped fiber amplifier 120 such that the input optical signal 105 and the pump laser radiation 126 can propagate simultaneously through the doped fiber amplifier 120. For instance, input optical signal 105a and the portion of pump laser radiation 126a are coupled by fiber combiner 150a and directed to doped fiber amplifier 120a. In at least one embodiment, the wavelength selective coupler 150 is configured as a wavelength division multiplexer (WDM) coupler as known in the art.

The doped fiber amplifier 120 is configured as a SM fiber with a core doped with erbium (Er), which in some instances may be co-doped with Yb. Although not specifically shown in the figures, passive SM input fiber from WDM coupler 150 is spliced to the input end of Er-doped fiber 120, and passive SM output fiber is spliced to the output end of Er-doped fiber 120 (thereby forming a gain block). The Er-doped fiber 120 amplifies the input optical signal 105 using pump laser radiation 126, which is provided at a wavelength of 980 nm. According to some embodiments, the EDFA has an optical power output of at least +15 dB, and in one embodiments is +17 dB.

The input signal 105 has a wide bandwidth, e.g., 40 nm, and according to one example, the input signal may have a wavelength range between 1528 nm-1566 nm. The EDFA is therefore configured to produce gain over a spectral width of at least 30 nm.

System 100 also includes one or more optical isolators 140, as known in the art. The isolator 140 may be placed downstream from EDFA 120 to prevent backreflection from traveling back upstream to the amplifier and/or laser diodes. One or more gain flattening filters (GFF) 145, as known in the art, is also included in system 100 and is positioned downstream from the isolator 140. A GFF is placed following the output isolator in order to flatten the gain spectrum.

Amplified signal light is output via delivery or transmission fiber 155. The EDFA gain block 124 (each shown as 124a, 124b, 124c, and 124d in FIGS. 2A and 2B) functions to amplify the input optical signal 105 and may include multiplexer 150, doped fiber amplifier 120, isolator 140, and GFF 145, with delivery fiber 155 as the output of the gain block 124.

Turning now to FIG. 5, an optical schematic is shown of a portion of the optical communication system 100 described above in reference to FIG. 2A. In certain embodiments, fiber pump laser system 110a is configured to output pump radiation at a wavelength of about 978 nm and fiber pump laser system 110b is configured to output pump radiation at a wavelength of about 983 nm. Once combined by the at least one combiner-splitter element 132a, the pump laser radiation has a wavelength of about 980 nm (assuming a 50/50 split). Pump laser radiation having power Pₐ from fiber pump laser system 110a and pump laser radiation having power P_{b} from fiber pump laser system 110b combine at combiner/splitter 132a pump laser radiation P_{ab}, which splits into two portions P_{ab}/2 (1) (and shown as 125a in FIG. 5) and P_{ab}/2 (2), each of which propagate at a wavelength of 980 nm. Fiber pump laser radiation portion 125a therefore has a power of P_{ab}/2, which is split again at splitter 132b into two more portions P_{ab}/4 (1) (which is shown as 126a in FIG. 5) and P_{ab}/4 (2), each of which has a wavelength of 980 nm and a power (assuming a 50/50 split) that is one quarter that of the combined pump power from 110a and 110b. This pump radiation is introduced to the Er-doped amplifier 120a along with input signal 105a, the latter of which is amplified and then output through delivery fiber 155a. The gain of the EDFA may be in the range from about 10-20 dB, and in some instance may be greater than 20 dB. For instance, in one embodiment, the gain of the EDFA is 22 dB.

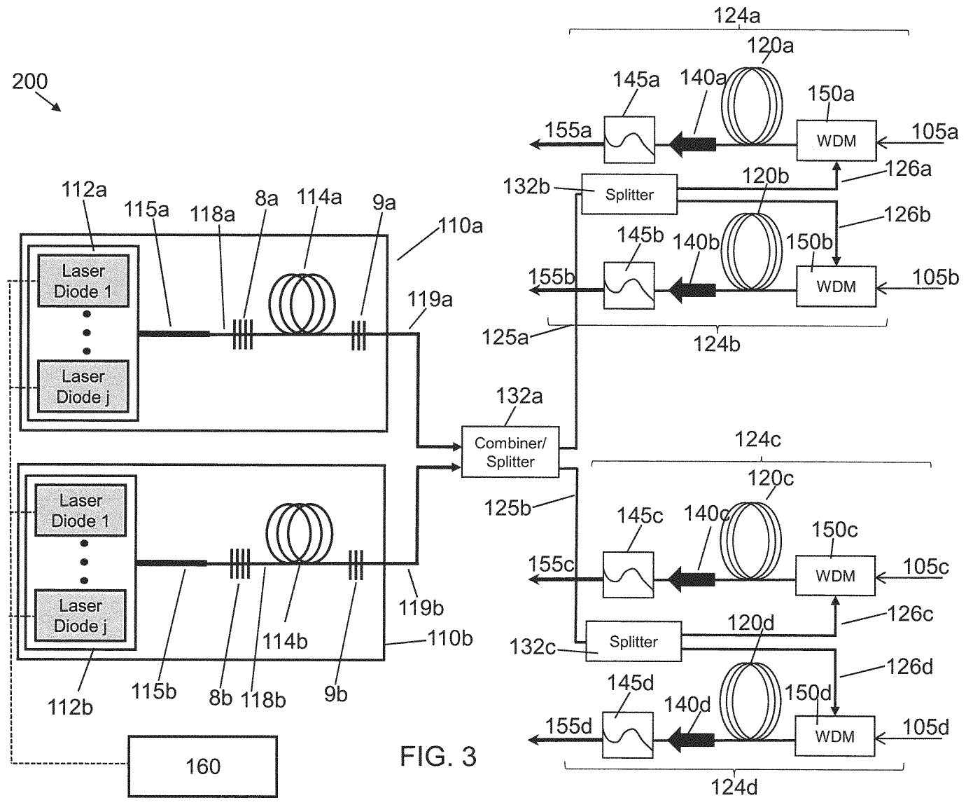

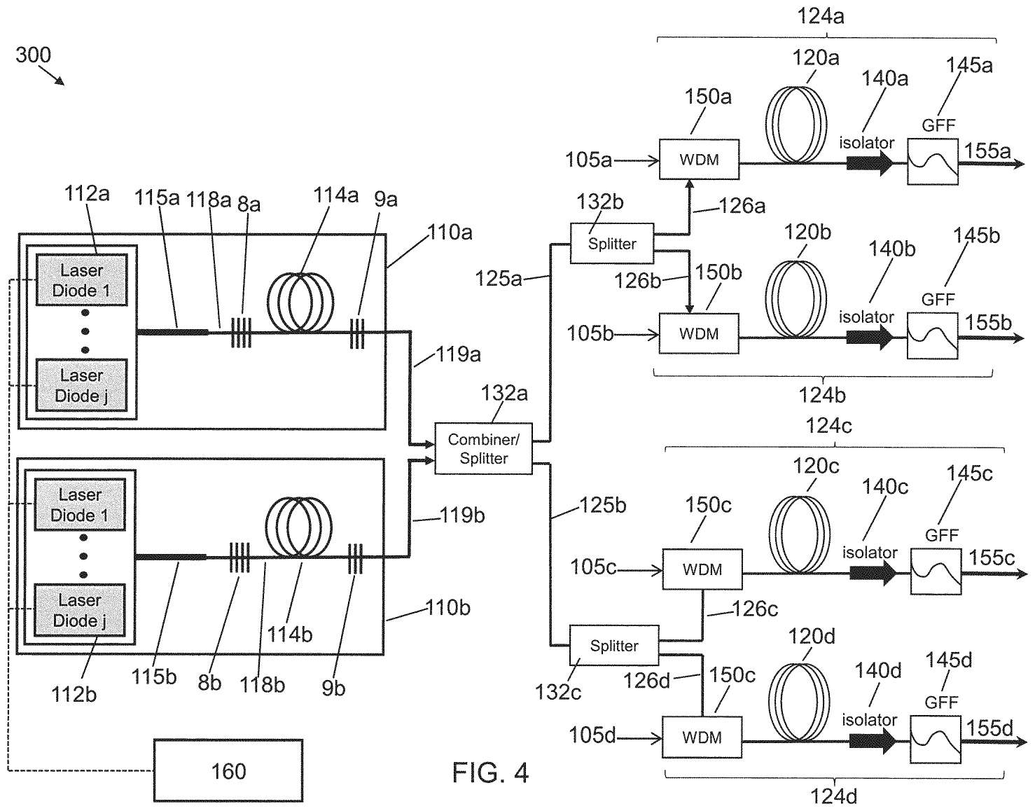

The optical communication systems 100 of FIGS. 2A and 2B are configured to be bidirectional such that at least one input optical signal (e.g., 105a, 105c) received by one of the doped fiber amplifiers 120 propagates in a first direction and at least one input optical signal (e.g., 105b, 105d) received by another doped fiber amplifier propagates in a second direction that is different than, and in some instances opposite, the first direction. According to other embodiments, the optical communication system may be configured to be unidirectional, as shown in the optical communication systems 200 and 300 of FIGS. 3 and 4 respectively. According to other embodiments, two or more optical communication systems can be included in an optical repeater, where one system amplifies input optical signals from one direction and another system amplifies input optical signals from a different direction. For instance, both systems 200 and 300 can be included in a single repeater. As such, one pair or set of fiber pump laser systems will amplify input signals from one direction and the second pair or set of pump laser systems will amplify input signals from the opposite direction.

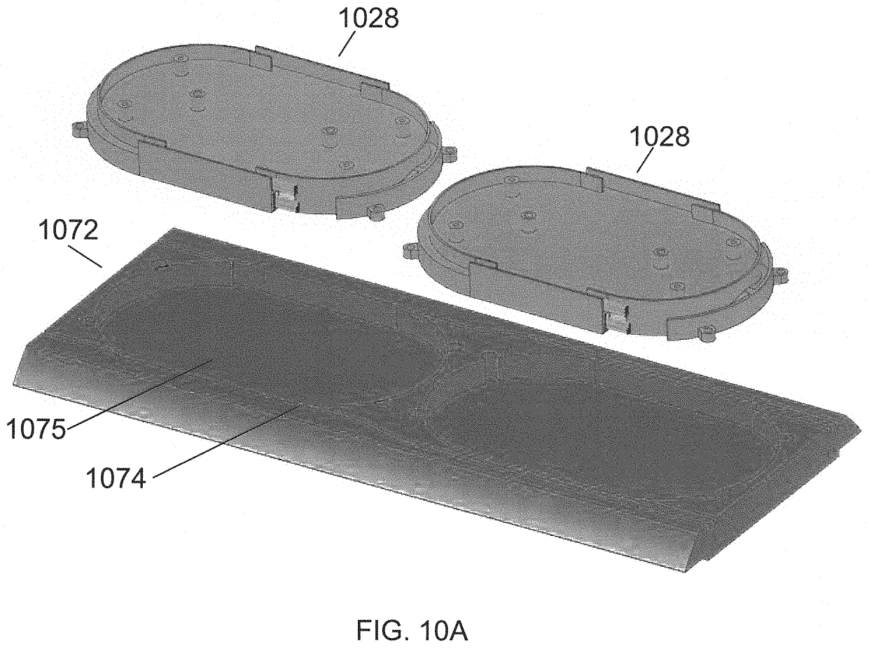

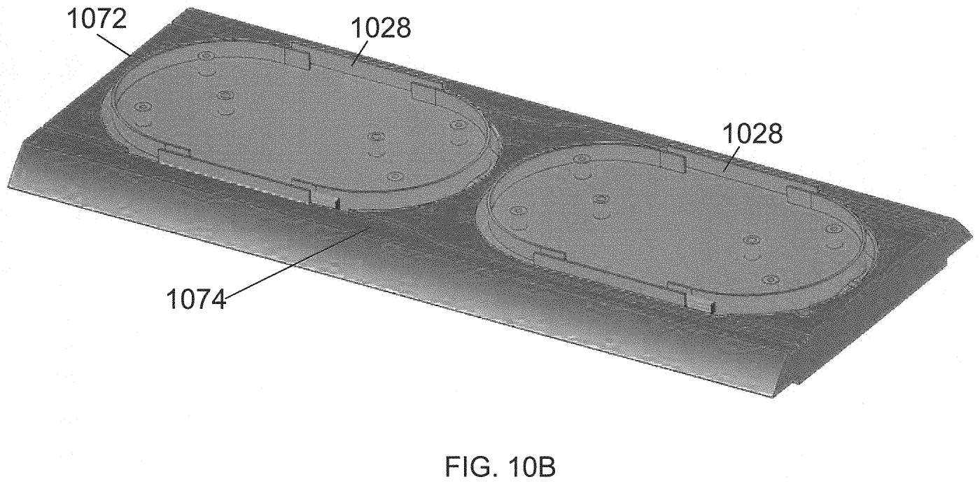

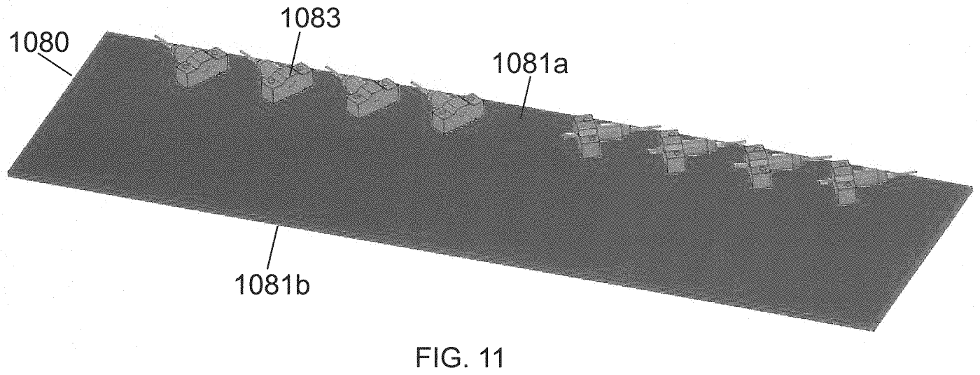

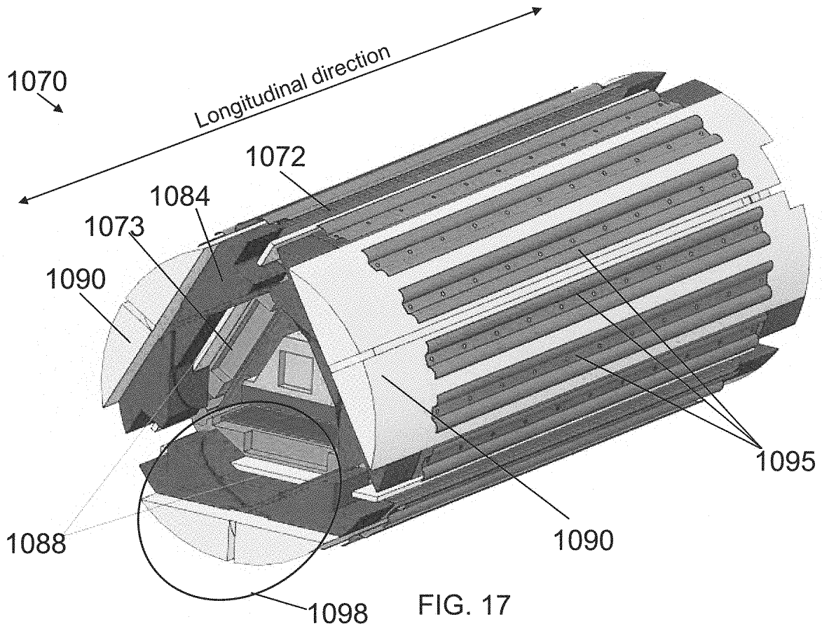

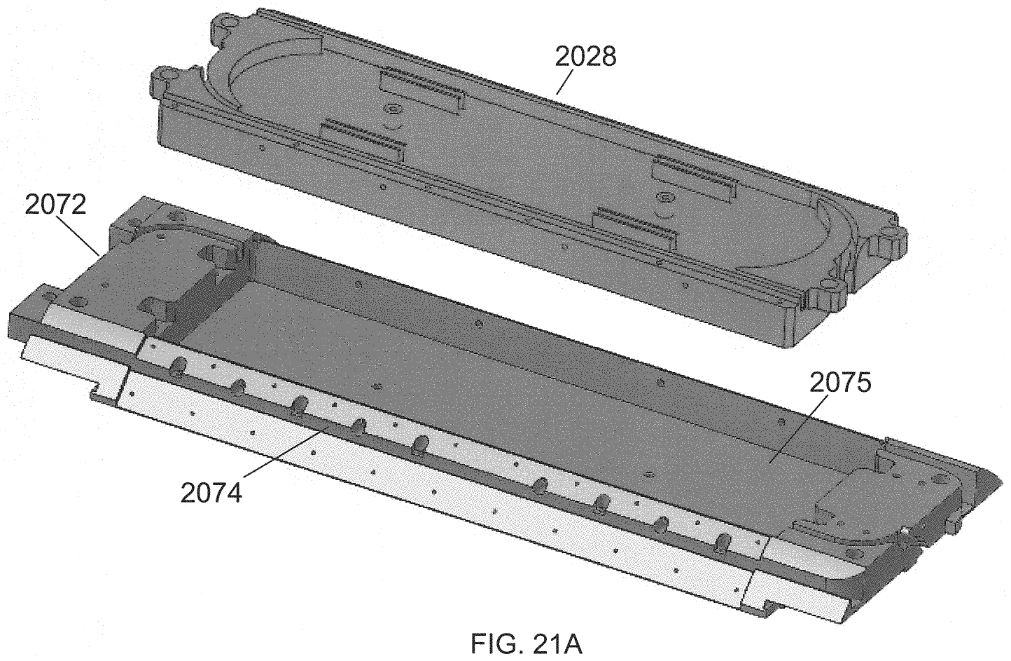

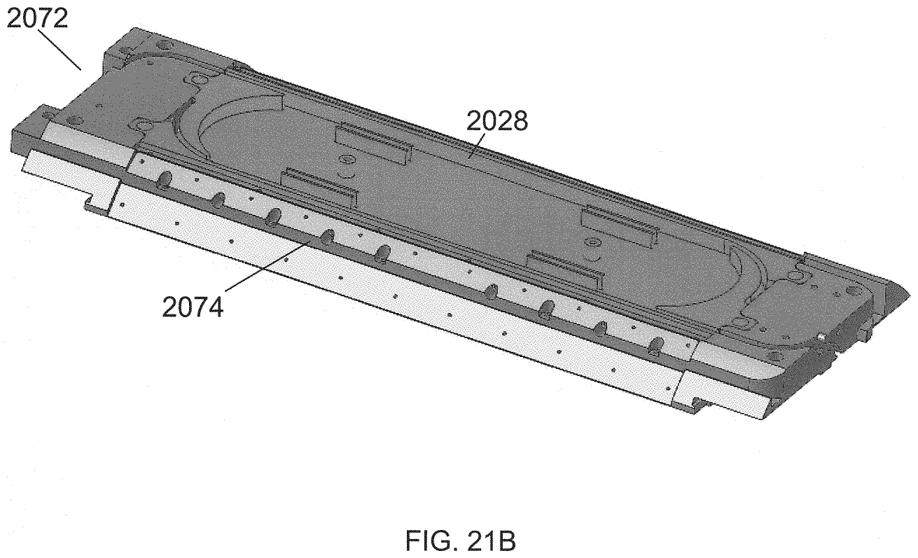

In accordance with another aspect of the invention, components of the optical communication system discussed above may be included in an undersea optical repeater. The optical repeater may include a plurality of fiber pump laser systems 110 and a plurality of gain block assemblies 124 as described above. One example of such an optical repeater is shown in FIGS. 10-19, with perspective views of the optical repeater 1070 shown in FIGS. 17-19. As described further below, the components of the optical repeater shown in FIGS. 10-14 are configured to receive six fiber pairs and to amplify input signals contained therein using six gain block modules that each include two EDFAs pumped by two fiber pump laser systems. The optical repeater with the six fiber pair configuration has a gain of 14 dB and an output power of +17 dB. However, it is to be understood that optical repeaters configured to receive greater than six fiber pairs, including 12, 16, 18, 24 and greater, are also within the scope of this disclosure based on the teachings herein. For instance, an optical repeater with a 12 fiber pair configuration and constructed according to the teachings included herein is shown in FIGS. 21-27. The number of laser diodes 112 included in the fiber pump laser system 110 can be increased, and/or the number of fiber pump laser systems 110 and/or the number of EDFAs can be increased per EDFA module (described in further detail below) in the repeater to accommodate increasing numbers of fiber pairs.

Referring now to FIGS. 10A and 10B, an amplifier tray assembly 1072 is shown in combination with two gain block modules 1028. The amplifier tray assembly 1072 has a first side or surface 1074 with a plurality of recesses 1075 that are each dimensioned to receive a gain block module 1028. FIG. 10B shows the gain block modules 1028 disposed in the respective recesses 1075. In this example, each gain block module 1028 includes at least two EDFA gain block assemblies 124 (which are not explicitly shown in the figures) as described above. For instance, each EDFA gain block assembly includes an erbium-doped fiber 120, an isolator 140, a GFF 145, and at least one WDM 150. The gain block module 1028 also includes the combiner-splitter elements 132 as described above.

Although the example shown in FIGS. 10A and 10B includes two gain block modules that each have two EDFA gain block assemblies, it is to be appreciated that other configurations may include more than two gain block modules and/or gain block modules that have more than two EDFA gain block assemblies.

A printed circuit board 1080 that is included in the optical repeater is shown in FIG. 11. The printed circuit board (PCB) 1080 has opposing outer faces 1081a and 1081b, and a plurality of photodetector diodes 1083 that are disposed on one of the outer faces (in the particular example shown in FIG. 11, the photodetector diodes 1083 are disposed on outer face 1081a). The photodetector diodes 1083 function to detect the input signal 105 prior to amplification.

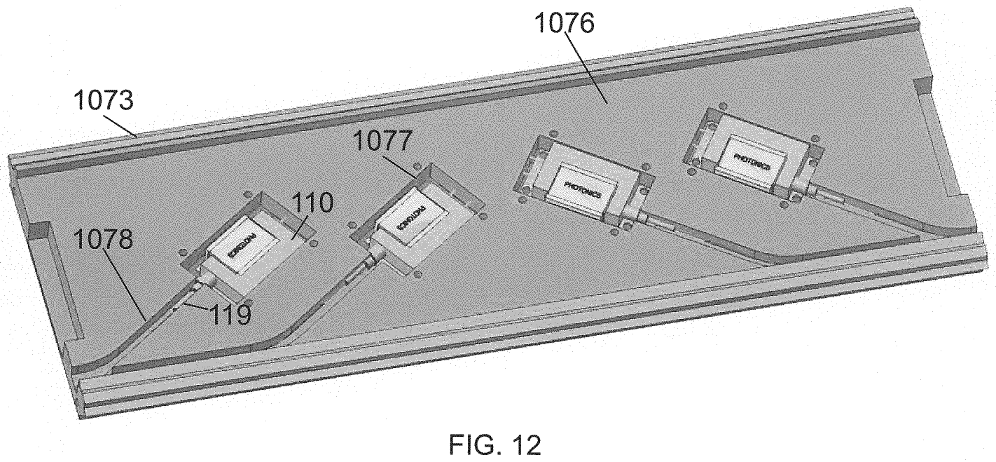

The optical repeater also includes a laser tray assembly 1073 configured to hold components of the fiber pump laser system 110 discussed above, with an example shown in FIG. 12. One side or surface 1076 of the laser tray assembly 1073 includes a plurality of recesses 1077 that are each dimensioned to receive a fiber pump laser system 110. A plurality of channels 1078 are also disposed in the surface 1076 of the laser tray assembly 1073, and these channels 1078 are configured to receive at least one of the SM delivery fibers 119 of the fiber pump laser system 110. The channels 1078 may be shaped and dimensioned to not only guide the fiber and keep it within the channel, but also to prevent detrimental effects to the fiber. For instance, the channels 1078 may be shaped so as to have angles and/or a radius of curvature that is less than the maximum bend radius of the fiber. The recesses 1077 holding the fiber pump laser systems 110 may also be arranged such that SM delivery fibers 119 can be output from two (or more in other configurations) individual fiber pump laser systems 110 and combined into a single channel. In this example, the recesses 1077 are each arranged at an angle.

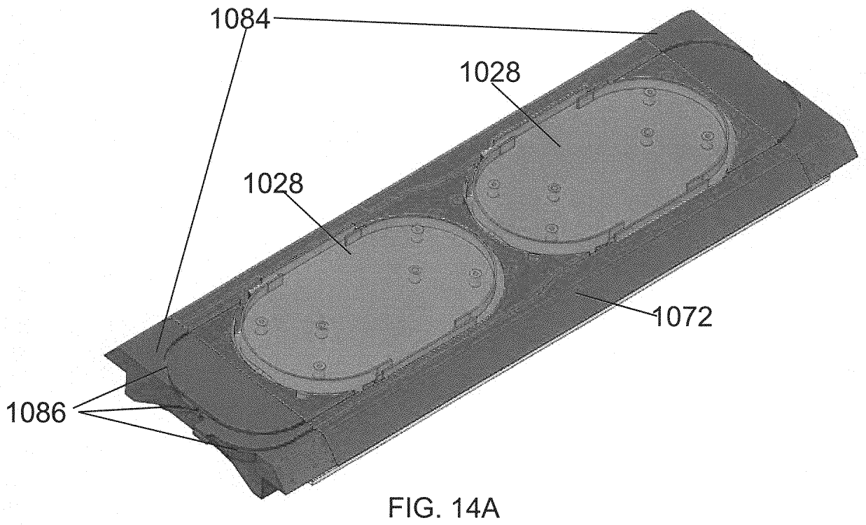

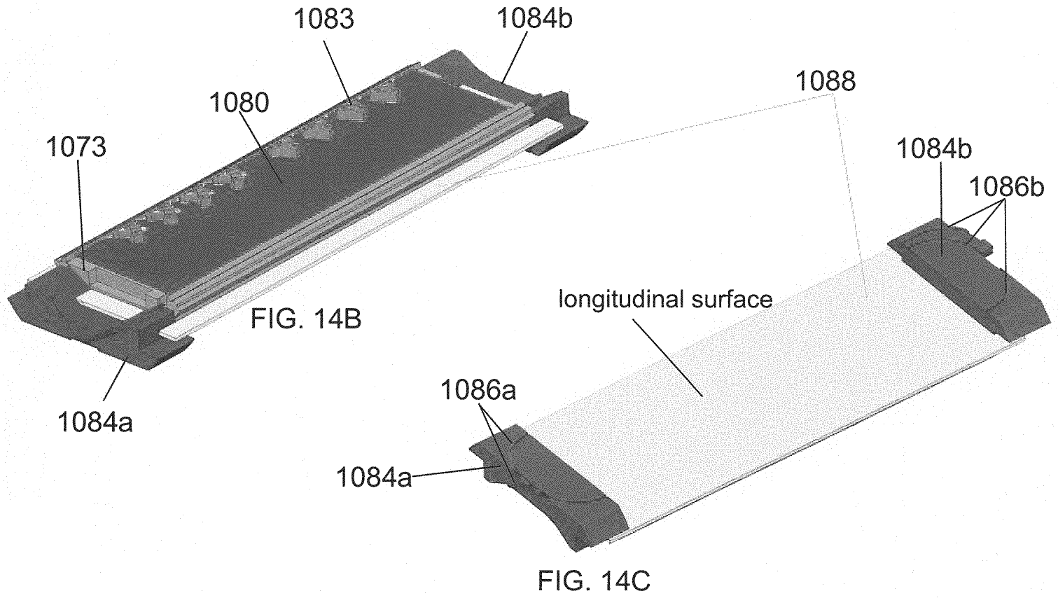

A fiber guide assembly 1084 is attached to at least a portion of opposing side surfaces or end portions of the amplifier tray assembly 1073, and is shown in FIGS. 14A-14C. The fiber guide assembly 1084 includes guiding channels 1086 that couple to channels 1078 on the surface 1076 of the laser tray assembly 1073. The fiber guide assembly 1084 functions to guide (via guiding channels 1086) the SM delivery fibers 119 to at least one of the gain block modules 1028 disposed on the surface 1074 of the amplifier tray assembly 1072. For example, the fiber guide assembly 1084 has two sections 1084a and 1084b (see FIGS. 14B and 14C), each disposed on an opposing end of the amplifier tray assembly 1072. Section 1084a has guiding channels 1086a to guide fiber containing optical energy from two (or more in other configurations) respective fiber pump laser systems 110 to at least one of the gain block modules 1028 disposed on the surface 1074 of the amplifier tray assembly 1072. Section 1084b has a similar arrangement.

The arrangement shown in FIGS. 10A, 10B, 12, and 14A-14C is configured for two fiber pump laser systems 110 to pump one gain block module 1028 (and therefore two gain block assemblies 124). However, other configurations are also possible according to this disclosure, one example of which includes gain block modules 1028 that accommodate four gain block assemblies 124 that are pumped by two fiber pump laser systems 110.

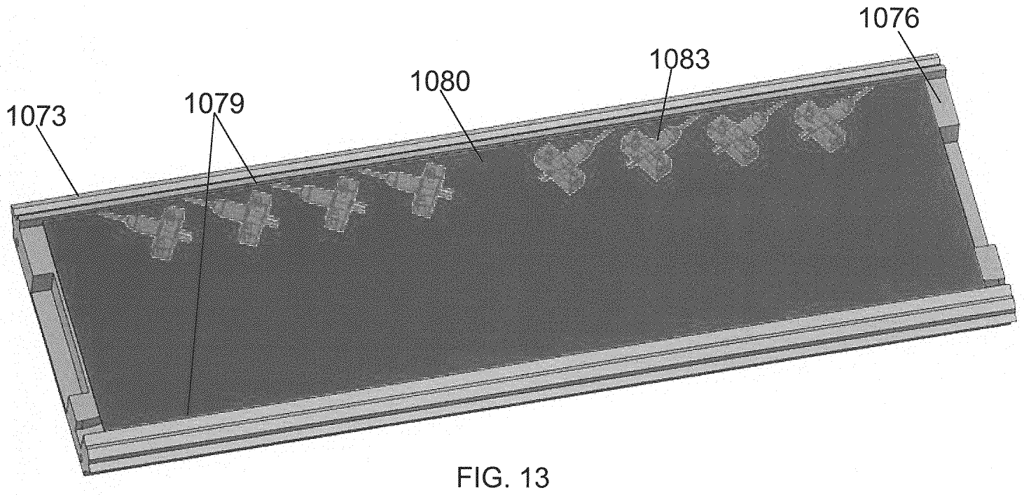

The surface 1076 of the laser tray assembly 1073 also includes slots 1079, as shown in FIG. 13, for receiving the PCB 1080. In this example, the slots 1079 form the outer boundaries of the longitudinal sides of the surface 1076 of the laser tray assembly 1073. The opposing outer face 1081b (i.e., the face that does not include the photodetector diodes 1083) of PCB 1080 may be disposed against the second side 1076 of the laser tray assembly 1073 and therefore “cover” the fiber pump laser systems 110 when the optical repeater is assembled.

The optical repeater also includes a thermally conductive ceramic member (also referred to as simply “ceramic member”), an example of which is shown as 1088 in FIGS. 14B and 14C. Each section of the fiber guide assembly 1084a and 1084b also attaches to end portions of the ceramic member 1088, as shown in FIG. 14C. The thermally conductive ceramic member 1088 is described in co-owned, co-pending U.S. patent application No. 62/653,980, titled “SUBMARINE OPTICAL REPEATER WITH HIGH VOLTAGE ISOLATION” filed on Apr. 6, 2018, which is incorporated herein by reference and referred to herein as “the '980 application.” The ceramic member 1088 separates the amplifier tray assembly 1072 from the laser tray assembly 1073. One side of a longitudinal surface of the ceramic member 1088 is disposed adjacent to the opposite side of surface 1074 of the amplifier tray assembly 1072 holding the gain block modules 1028. The opposite side of the longitudinal surface of the ceramic member 1088 is disposed adjacent to the opposite side of surface 1076 of the laser tray assembly 1073 holding the fiber pump laser systems 110. In some instances, one or both of the respective amplifier and laser tray assemblies 1072 and 1073 are directly attached to the ceramic member 1088.

As explained in the '980 application, the ceramic member 1088 is a planar structure that functions to electrically isolate the high voltage repeaters from the surrounding water and to also thermally couple the repeater to the surrounding water for purposes of maintaining the operating temperature of the repeater within an acceptable temperature range, i.e., to facilitate heat transfer from the repeater through the ceramic material to the surrounding water. The ceramic member 1088 is constructed from a material that has a relatively high thermal conductivity and a relatively high dielectric constant. Non-limiting examples of such a material include aluminum nitride and beryllium oxide. In embodiments, each of the ceramic members 1088 may have a thermal conductivity of: greater than about 25 Watts/meter-Kelvin (W/m-K); greater than about 50 W/m-K; greater than about 100 W/m-K; greater than about 125 W/m-K; greater than about 150 W/m-K; greater than about 175 W/m-K; greater than about 200 W/m-K; greater than about 250 W/m-K; or greater than about 300 W/m-K. In embodiments, each of the ceramic members 1088 may have a dielectric constant of: greater than about 50 kilovolts/centimeter (kV/cm); greater than about 75 kV/cm; greater than about 100 kV/cm; greater than about 125 kV/cm; greater than about 150 kV/cm; or greater than about 175 kV/cm.

The use of the ceramic member 1088 offers a significant improvement over prior optical repeater systems that employ an electrical insulator having a relatively low thermal conductivity to isolate the relatively high voltage components, such as the optical couplers and power supply circuitry, from the surrounding water at a relatively low earth ground voltage. Such prior systems required a significantly larger surface area to effectively dissipate the heat generated by the optical repeaters.

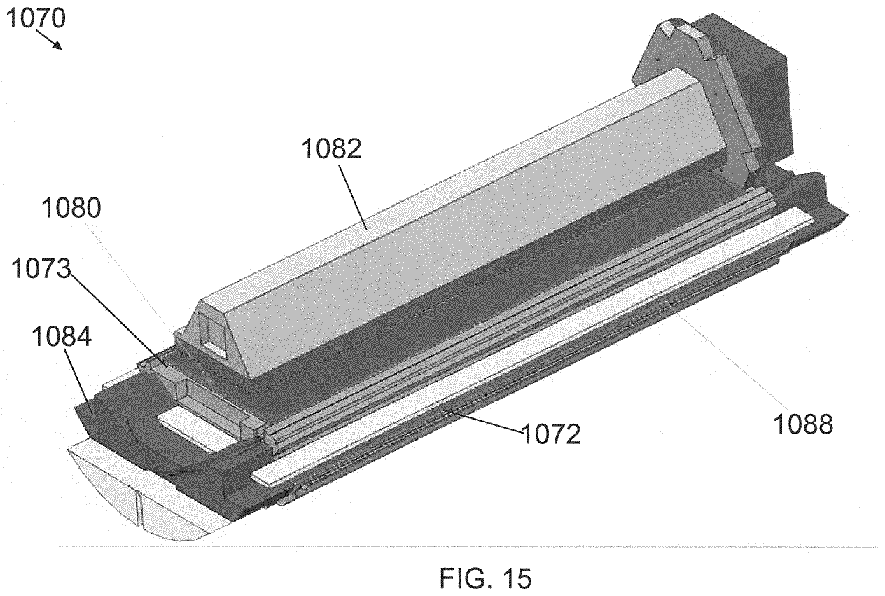

A portion of an optical repeater 1070 is shown in FIG. 15 that includes the amplifier tray assembly 1072, laser tray assembly 1073, PCB 1080, fiber guide assembly 1084, and ceramic member 1088 discussed above. The optical repeater 1070 also includes a power distribution member 1082, which is also discussed in the '980 application. The power distribution member 1082 functions to supply power to components of the optical repeater 1070, including the diode module 107 of the fiber pump laser system 110.

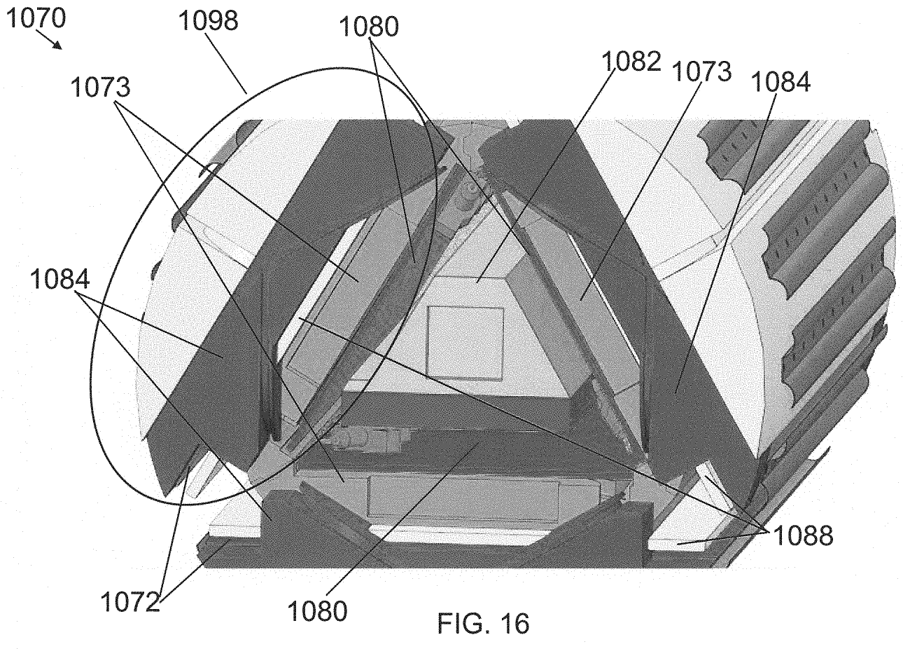

In some embodiments, the ceramic members 1088 may be arranged (with other components) to form a triangular hollow structure, as seen in the cross-sectional view of the optical repeater 1070 shown in FIG. 16. This type of configuration is also discussed in the '980 application. Each “leg” of the triangle is constructed in a similar manner and forms an amplifier or EDFA module 1098 that includes the ceramic member 1088, amplifier tray assembly 1072 (and contents), laser tray assembly 1073 (and contents), PCB 1080, fiber guide assembly 1084, cover panel 1090 (described below), and flanges 1095 (described below). As shown in FIG. 16, each laser tray assembly 1073 may connect to another laser tray assembly along an outer (longitudinal) edge, although in alternative configurations a connector may mechanically couple one tray assembly to another tray assembly. The internal volume of the triangular structure also includes the power distribution member 1082.

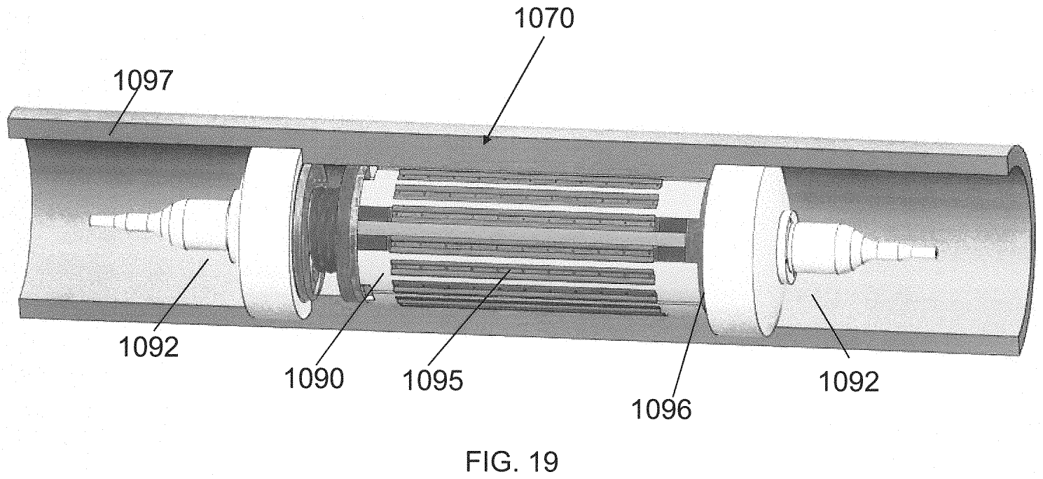

A perspective view of the optical repeater 1070 is also shown in FIG. 17. A cover panel 1090 constructed from a thermally conductive material attaches to an outer surface of the structure, and is also described in the '980 application. The cover panel 1090 assists in the transfer of thermal energy from the components and/or circuitry disposed in, on, or about the hollow triangular structure formed by the ceramic members 1088, and is maintained at the potential or voltage of the surrounding environment, e.g., earth ground potential. In the example shown in FIG. 17, the cover panel 1090 attaches to the fiber guide assembly 1084 and surface 1074 of the amplifier tray assembly 1072 and is positioned adjacent to the gain block modules 1028 of each EDFA module 1098 that forms one “leg” of the triangle. The cover panel 1090 is shaped to be received by a circular sleeve or housing (e.g., sleeve 1097 of FIG. 19) that further surrounds the optical repeater 1070. For instance, the outer surface of the cover panel 1090 may be curved. In various embodiments, the thermally conductive material 1090 may include any number and/or combination of currently available and/or future developed materials capable of effectively and efficiently conveying thermal energy from the ceramic members 1088 to the housing 1097. In embodiments, the cover panel 1090 may include one or more thermally conductive and electrically insulative materials, such as aluminum oxide, and/or other ceramic materials having a thermal conductivity of: greater than about 25 Watts/meter-Kelvin (W/m-K); greater than about 50 W/m-K; greater than about 100 W/m-K; greater than about 125 W/m-K; greater than about 150 W/m-K; greater than about 175 W/m-K; greater than about 200 W/m-K; greater than about 250 W/m-K; or greater than about 300 W/m-K.

The outer surface of the cover panel 1090 also includes flange members 1095 positioned along at least a portion of the longitudinal axis of the optical repeater 1070. The flange members 1095 function to position and hold the repeater 1070 in place within the circular sleeve 1097 and to also transfer heat to the outer housing 1097 (which then transfers the heat to the external environment). The flange members 1095 may be constructed from a metallic material, such as copper or a copper alloy such as copper-beryllium. In some instances, flange member 1095 may have a double flange arrangement, as shown in FIG. 17.

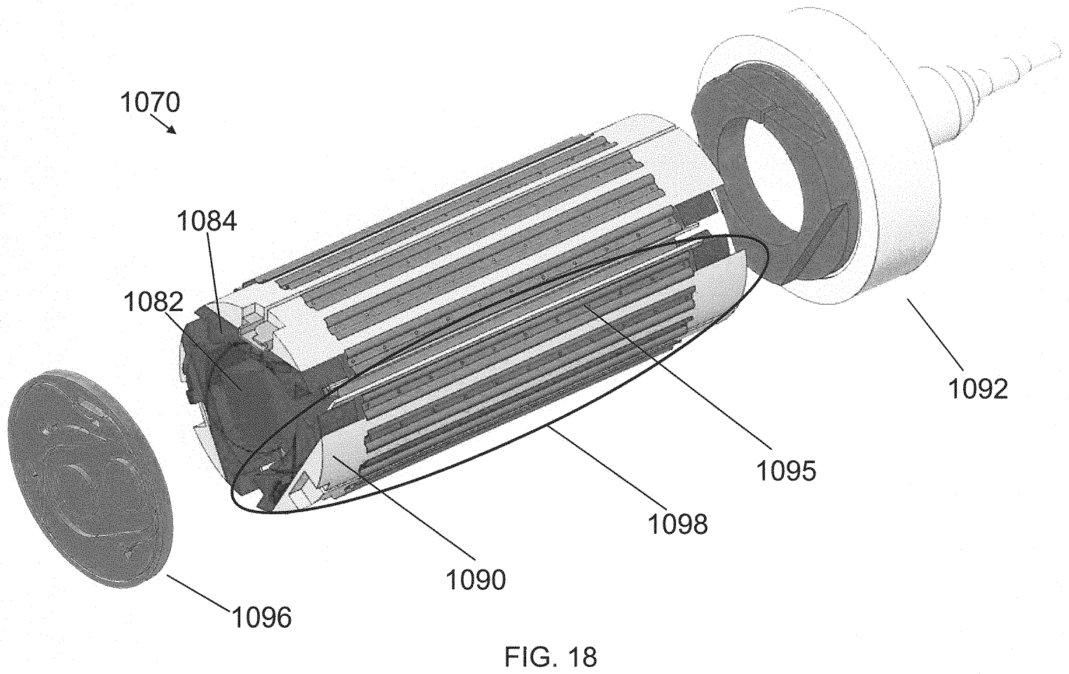

The optical repeater 1070 also includes an organizer endplate 1096, as shown in FIG. 18. The organizer endplate 1096 is attached to one end portion of the optical repeater and couples to the fiber guide assemblies 1084 and the cover panels 1090 (of each “leg” of the triangular configuration) and may be used for aggregating the optical fibers from each EDFA module 1098 and arranging them to be sent through the end portion of the repeater. Both end portions of the optical repeater 1070 also include a bulkhead 1092, as shown in FIGS. 18 and 19. The bulkhead 1092 may include an endplate (e.g., see FIG. 18), and is used to close off the housing 1097 (described below) from the external environment. The bulkhead 1092 therefore functions with the housing 1097 to form a pressure vessel that houses the EDFA modules 1098 and power distribution member 1082 and is designed to withstand the high hydrostatic pressures experienced in the undersea environment. The bulkhead 1092 also functions to provide a watertight feed (hermetic seal) for the optical fibers and power sources fed from the external cable into the interior of the pressure vessel (and vice versa).

FIG. 19 also shows the optical repeater 1070 disposed within a circular sleeve or housing 1097 that functions to protect the repeater during installation and operation. The housing 1097 in some implementations may function to hermetically seal the optical repeater from the external environment. The housing 1097 may be constructed from one or more metals, non-limiting examples of which include aluminum and/or aluminum-containing compounds, stainless steel, beryllium and/or beryllium-containing compounds, titanium and/or titanium-containing compounds, and similar materials. In embodiments, the housing 1097 may have a thermal conductivity equal to or greater than the ceramic member 1088.

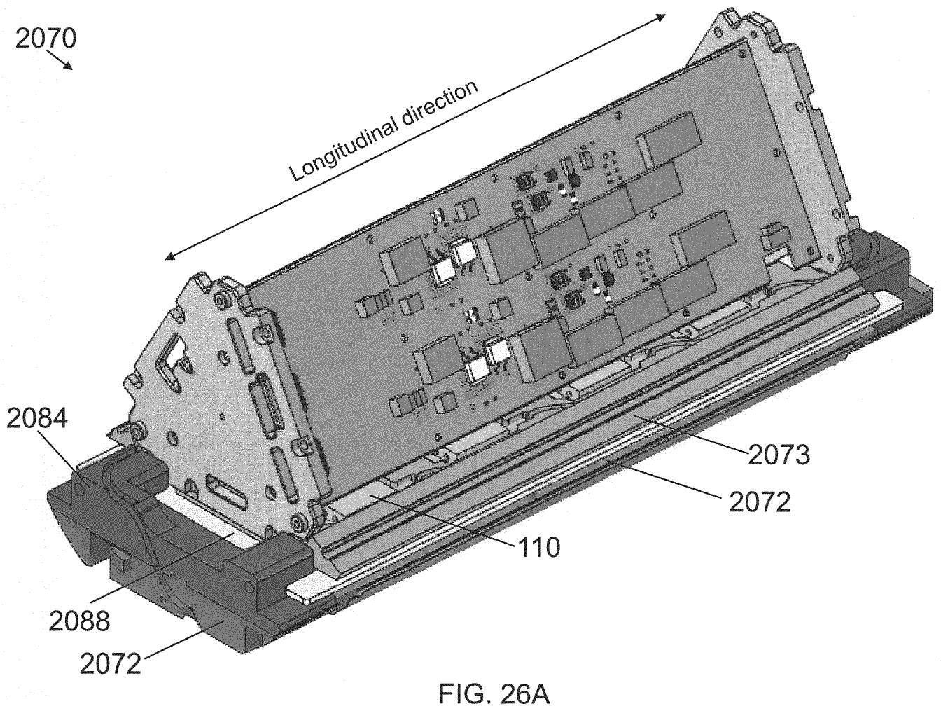

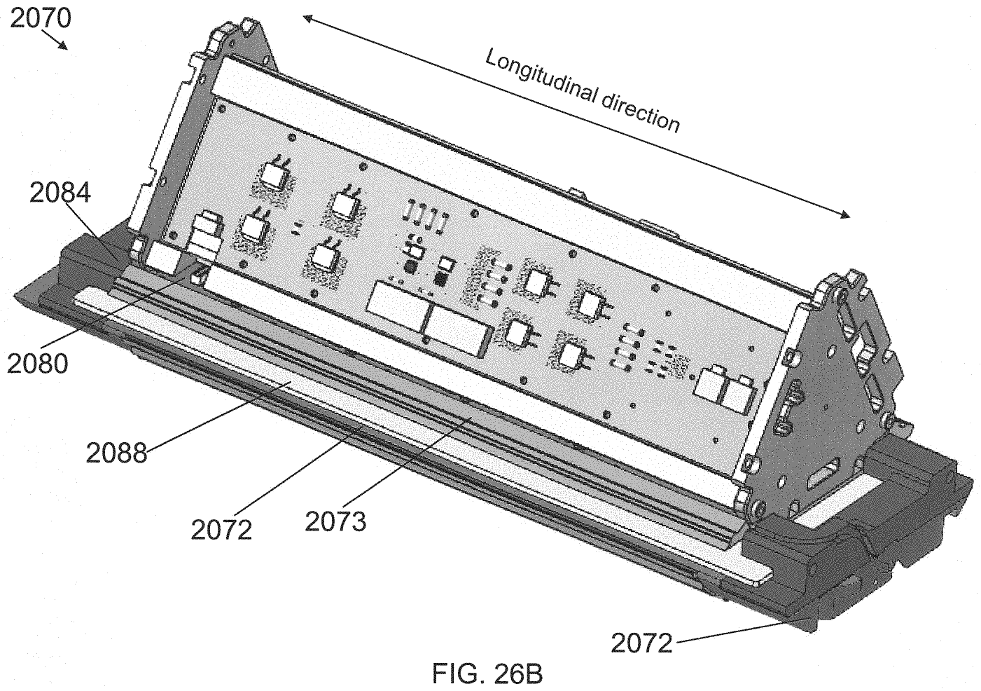

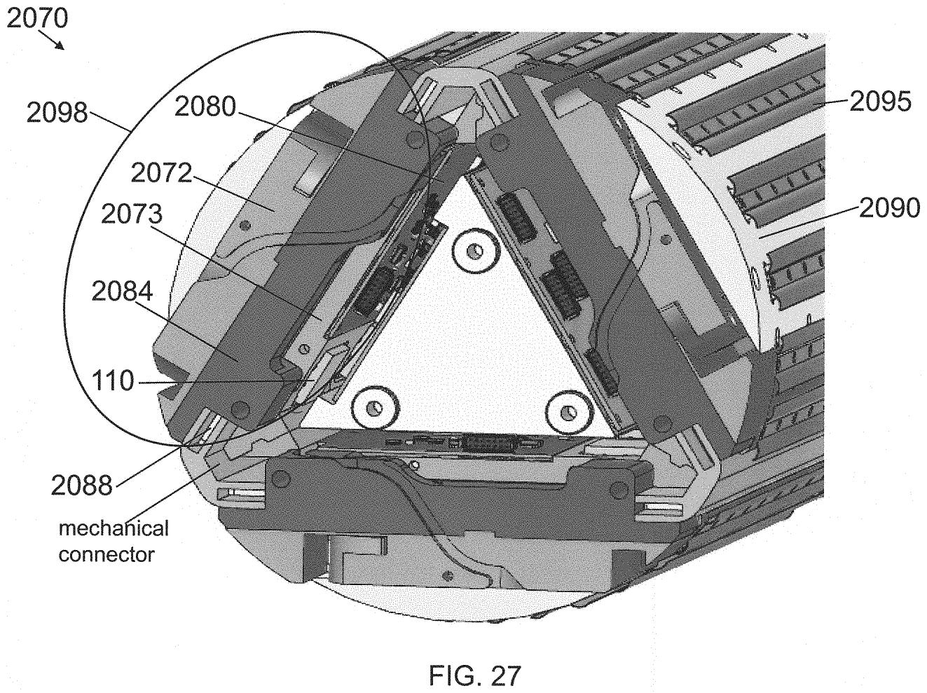

A second example of an optical repeater is shown in FIGS. 21-27, with perspective views of the optical repeater 2070 shown in FIGS. 26A, 26B, and 27. According to this example, the optical repeater 2070 is configured to receive 12 fiber pairs and to amplify input signals contained therein. Within the repeater the 12 fiber pairs are divided into 3 sets of 4 fiber pairs. Each set of 4 fiber pairs is amplified by amplifiers in a tray similar to that shown in FIGS. 21A and 21B (described in further detail below). Four fiber pump laser systems are used to pump the eight EDFAs in a given tray. Each group of four EDFAs are pumped by two fiber pump laser systems (such as the arrangement indicated in FIG. 2A). The optical repeater with the twelve fiber pair configuration has a gain in a range of 14-22 dB and an output power of +17 dB.

Referring to FIGS. 21A and 21B, an amplifier tray assembly 2072 is shown in combination with one gain block module 2028. The amplifier tray assembly 2072 has a first side or surface 2074 configured with a recess 2075 dimensioned to receive the gain block module 2028. FIG. 21B shows the gain block module 2028 disposed in the respective recess 2075. In this example, each gain block module 2028 includes at least eight EDFA gain block assemblies 124 (which are not explicitly shown in the figures) and the combiner-splitter elements as described above. Four EDFA gain assemblies may be arranged on each side of the gain block module 2028.

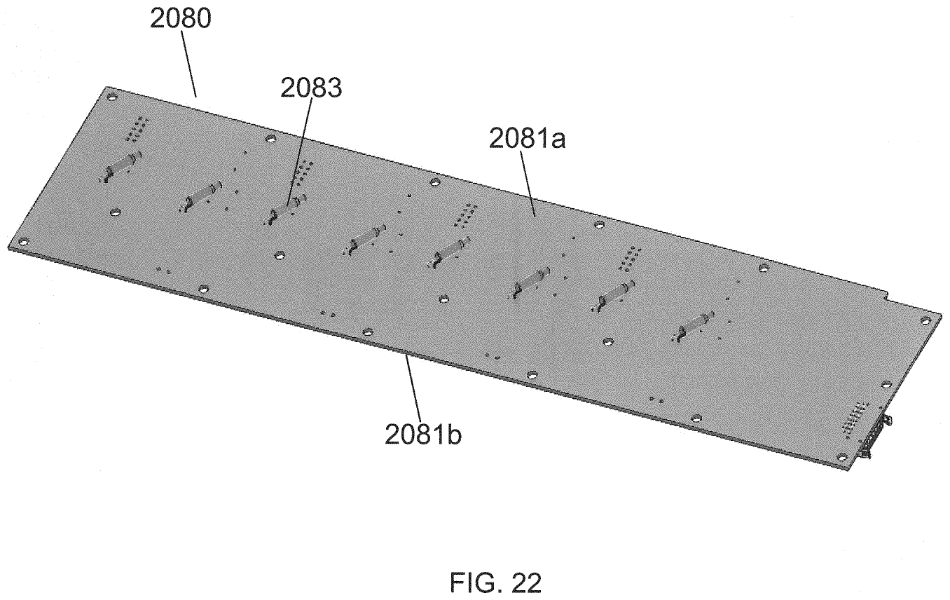

A printed circuit board 2080 included in the optical repeater is shown in FIG. 22. The PCB 2080 has opposing outer faces 2081a and 2081b, and a plurality of photodetector diodes 2083 that are disposed on outer face 2081a in a similar manner as described above in reference to FIG. 11.

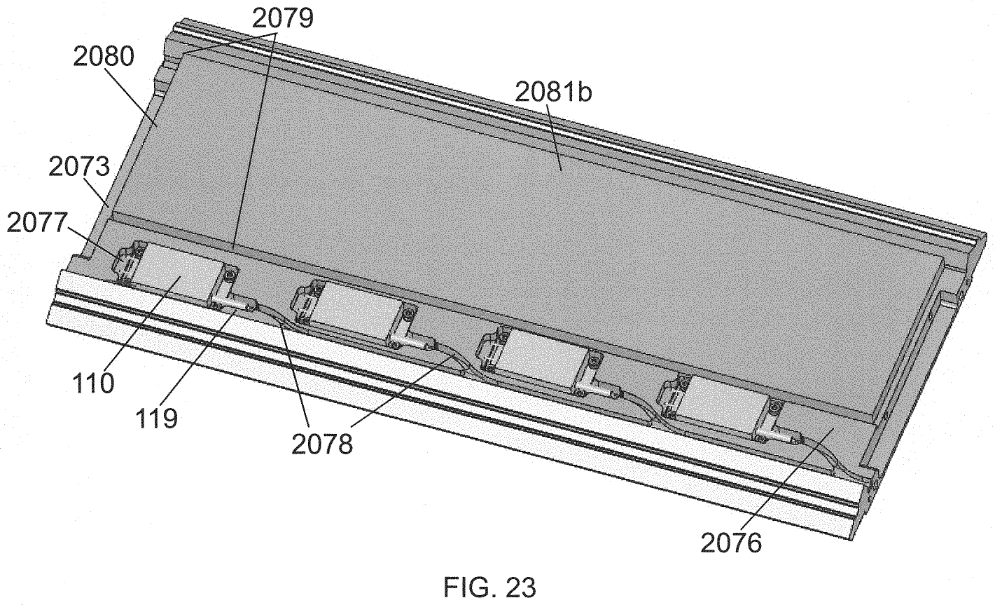

The optical repeater also includes a laser tray assembly 2073 configured to hold components of the fiber pump laser system 110 discussed above, with an example shown in FIG. 23. One side or surface 2076 of the laser tray assembly 2073 includes a plurality of recesses 2077 that are each dimensioned to receive a fiber pump laser system 110. A plurality of channels 2078 configured to receive at least one of the SM delivery fibers 119 of the fiber pump laser systems 110 are also disposed in the surface 2076 of the laser tray assembly 2073. As mentioned above, the channels 2078 may be shaped and dimensioned to both guide fiber and to prevent detrimental effects to the fiber. Unlike the arrangement shown in FIG. 12, these recesses 2077 are arranged in a linear configuration.

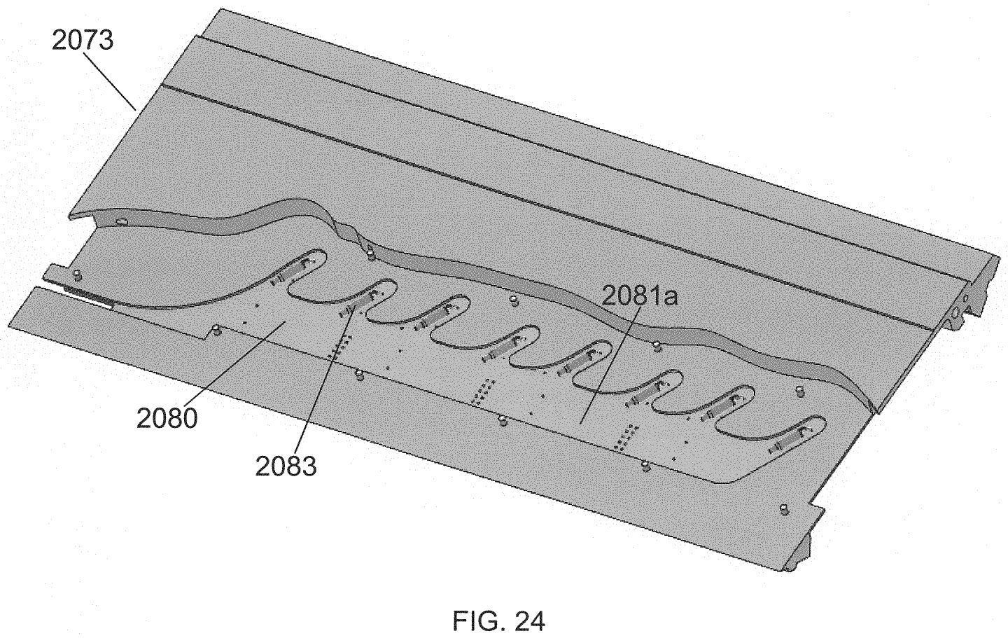

The surface 2076 of the laser tray assembly 2073 also includes grooves or slots 2079 extending in a longitudinal direction that are dimensioned to receive the PCB 2080. As indicated in FIG. 23, outer face 2081a of the PCB 2080 (i.e., the face that includes the photodetector diodes 2083), is disposed against the surface 2076 of the laser tray assembly. This surface 2076 therefore contains recesses or other features for receiving the photodetector diodes 2083. This arrangement is shown in the cutaway of the opposing side of laser tray assembly 2073 as shown in FIG. 24. The opposing outer face 2081b of PCB 2080 may thus be disposed outwardly of the laser tray assembly 2073 as indicated in FIG. 23.

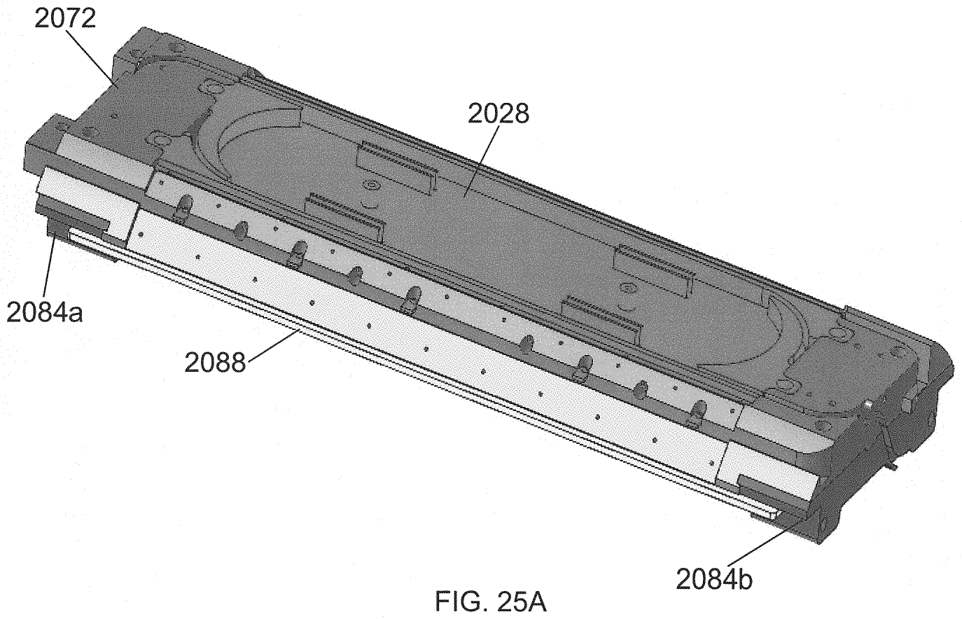

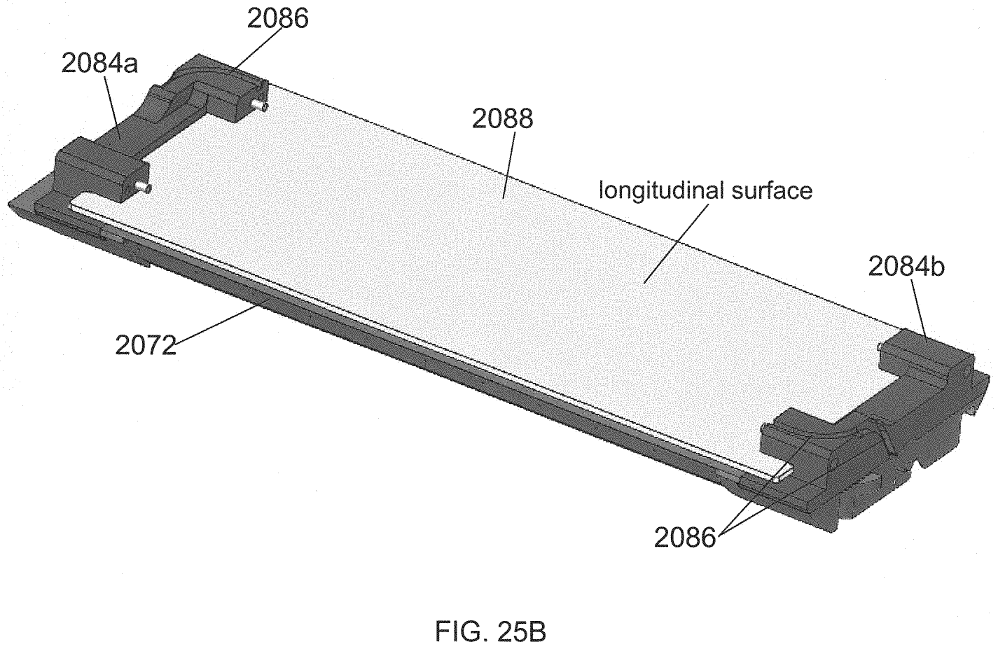

A fiber guide assembly 2084 is attached to at least a portion of the opposing end portions of the amplifier tray assembly 2073, and is shown in FIGS. 25A and 25B. The fiber guide assembly 2084 includes guiding channels 2086 that couple to channels 2078 on the surface 2076 of the laser tray assembly 2073 and channels disposed on the surface 2074 (and other surfaces) of the amplifier tray assembly 2072, and therefore functions in a similar manner as fiber guide assembly 1084 described above in directing fibers containing pump energy from the fiber pump laser systems 110 to the gain block module 2028. Surfaces of the amplifier tray assembly 2072 and the laser tray assembly 2073 also include channels for guiding fibers.

A ceramic member 2088, similar to ceramic member 1088 described above and in the '980 application, is also included in the optical repeater and is shown in FIGS. 25A and 25B. Each section of the fiber guide assembly 2084a and 2084b also attaches to end portions of the ceramic member 2088, as indicated in FIG. 25B. In a similar manner as described above in reference to ceramic member 1088, ceramic member 2088 is positioned between and separates the amplifier tray assembly 2072 from the laser tray assembly 2073. As can most clearly be seen in FIG. 25A, one side of the longitudinal surface of the ceramic member 2088 is disposed adjacent to the “back” side of the amplifier tray assembly 2072 (i.e., the opposing side of surface 2074 that holds the gain block module 2028). As best shown in FIG. 26A, the second opposing side of the longitudinal surface of the ceramic member 2088 is disposed adjacent to the “back” side of the laser tray assembly 2073 (i.e., the opposing side of surface 2076 that holds the fiber pump laser systems 110. One or both of the amplifier and laser tray assemblies 2072 and 2073 may be directly attached to the ceramic member 2088.

A portion of the optical repeater 2070 is shown in the two perspective views presented by FIGS. 26A and 26B. As with the optical repeater 1070 described above in reference to FIGS. 10-19, the optical repeater 2070 can be constructed to form a triangular structure formed from three separate EDFA modules 2098 (see FIG. 27). FIGS. 26A and 26B include a view of how the amplifier tray assembly 2072, laser tray assembly 2073, PCB 2080, fiber guide assembly 2084, and ceramic member 2088 are assembled together. The interior volume of the triangular structure includes a power distribution member as described previously (but is not explicitly shown in FIGS. 26A and 26B). As indicated in FIGS. 27A and 27B, PCBs (separate from PCB 2080) may also be included in the interior volume of the optical repeater 2070.

As shown in FIG. 27, each EDFA module 2098 forms one “leg” of the triangular configuration and includes the ceramic member 2088, amplifier tray assembly 2072 (and contents), laser tray assembly 2073 (and contents), PCB 2080, fiber guide assembly 2084, cover panel 2090 (similar to that described previously in reference to cover panel 1090), and flanges 2095 (similar to that described previously in reference to flanges 1095). Each laser tray assembly 2073 may connect to another laser tray assembly along an outer (longitudinal) edge, and each amplifier tray assembly 2072 may connect to another amplifier tray assembly via a mechanical connector, as shown in FIG. 27. The cover panel 2090 is a curved structure and is constructed from a thermally conductive material (as described above) and attaches to an outer surface of the repeater structure. In the example shown in FIG. 27, the cover panel 2090 attaches to the amplifier tray assembly 2072 and adjacent to the gain block module 2028 of each EDFA module 2098. The outer surface of the cover panel 2090 also includes flange members 2095 positioned along at least a portion of the longitudinal axis of the optical repeater 2070. As indicated in FIG. 27, flange members 2095 are also attached to an outer surface of the amplifier tray assembly 2072.

The exterior of the optical repeater 2070 is shaped to be received by a circular sleeve or housing similar to sleeve 1097 of FIG. 19 that further surrounds the optical repeater 2070. The structure of the optical repeater 2070 also includes bulkheads and endplates similar to those described above in reference to FIGS. 18 and 19 and for purposes of brevity are not further described here.

As previously discussed, the ability to easily add more laser diodes 112 to the fiber pump laser system 110 allows for a scalable pumping scheme. As higher fiber counts are added, the pump power can be increased without substantially impacting the size of the fiber pump system or the optical repeater that includes these pump systems. The optical repeater 1070, as well as other configurations consistent with the teachings in this disclosure, may be dimensioned (i.e., length, diameter) to accommodate existing undersea repeater distribution systems, such as cable-laying components associated with cable-laying vessels, cable drums for optical fibers, power feed equipment, and cable-retrieval components. For instance, gimbals are attached at each longitudinal end of the optical repeaters 1070 and 2070 that function as bend-limiting devices that limit the maximum angle that the connecting fiber optic cable can bend during deployment (and retrieval) activities. The gimbals allow for the optical repeater to articulate around a cable ship bow sheave, which can have a diameter of three meters. Depending on the maximum bend angle of the gimbal (e.g., 40-60 degrees), the repeater is sized to be able to be accommodated by the bow sheave. Current repeaters can be several feet in length and less than a foot in diameter.

The optical repeaters 1070 and 2070, as well as other configurations consistent with the teachings in this disclosure, are also configured to accommodate more fiber pairs than existing optical repeaters that do not include the fiber pump laser system 110 while using the same amount of power. For example, a conventional optical repeater having two EDFAs pumped by two laser diodes and configured to receive one fiber pair and a certain power feeding current can be replaced with an optical repeater as disclosed herein having a modular structure where in one module four EDFAs are pumped by two fiber pump laser systems and is configured to receive two fiber pairs using the same amount of power feeding current.

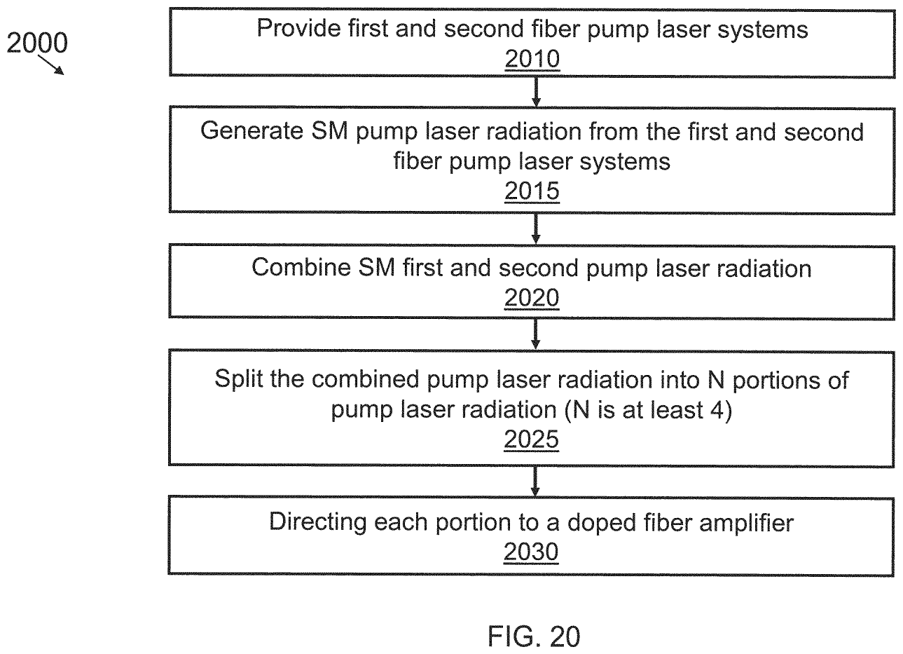

FIG. 20 illustrates an example method, shown generally at 2000, for an optical communication system having increased reliability consistent with the present disclosure. In act 2010, first and second fiber pump laser systems may be provided. Each fiber pump laser system may include, for example, at least two laser diodes, an active fiber optically coupled to the at least two laser diodes, and a MM passive fiber disposed between the at least two laser diodes and the active fiber. The fiber pump laser system may also include an input SM passive fiber and an output SM passive fiber. An input end of the input SM passive fiber is coupled to the MM passive fiber and an output end of the input SM passive fiber is coupled to an input end of the active fiber. The MM passive fiber has a tapered free end with diameter that matches a cladding diameter of the input SM passive fiber. An input end of the output SM passive fiber is coupled to an output end of the active fiber. The MM passive fiber, the active fiber, and the input SM passive fibers are each provided as photonic crystal fibers.

SM pump laser radiation from each of the first and second fiber pump laser systems is generated in act 2015. The first and second pump laser radiations are combined at act 2020, and split in act 2025 into N portions, where N is at least four. Each portion of pump laser radiation may be directed to a doped fiber amplifier in act 2030.

While FIG. 20 illustrates various acts according to an embodiment, it is to be understood that not all of the operations depicted in FIG. 20 are necessary for other embodiments. Indeed, it is fully contemplated herein that in other embodiments of the present disclosure, the acts depicted in FIG. 20 and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

Aspects of this disclosure are thus directed to power-limited optical communication systems having increased amplification capacity and reliability. In general, an optical communication system may be configured with fiber pump laser systems to increase data capacity (i.e., more fiber pairs) and reliability over the data capacity and reliability of an existing optical communication system while keeping power consumption at the same level as that of the existing optical communication system. In addition, optical repeaters configured with the fiber pump laser system are sized so as to be compatible with existing cable-laying distribution equipment. To realize such improvements, an example EDFA may utilize a fiber pump system having an active fiber and at least two fiber laser diodes to which is coupled a MM passive fiber having a tapered free end. The additional power generated by this fiber pump system facilitates increases in amplification capacity. The fiber pump system also increases the reliability of the system by decreasing the percentage of pump power lost when a laser diode stops functioning.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated reference is supplementary to that of this document; for irreconcilable inconsistencies, the term usage in this document controls. Moreover, titles or subtitles may be used in the specification for the convenience of a reader, which shall have no influence on the scope of the present invention.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. An optical communication system, comprising:
a first fiber pump laser system having a first single mode (SM) fiber output configured to output a first pump laser radiation;
a second fiber pump laser system having a second SM fiber output configured to output a second pump laser radiation,
wherein each of the first and second fiber pump laser systems include at least two laser diodes, an active fiber optically coupled to the at least two laser diodes, and a multimode (MM) passive fiber disposed between the at least two laser diodes and the active fiber;
at least one combiner-splitter element configured to combine the first pump laser radiation and the second pump laser radiation and to transmit N portions of pump laser radiation; and
N doped fiber amplifiers, where N is at least four and each doped fiber amplifier is configured to
receive one portion of the N portions of pump laser radiation and an input optical signal to be amplified,
amplify the input optical signal into an amplified optical signal, and
transmit the amplified optical signal.

2. The optical communication system of claim 1, wherein each laser diode is configured to provide about 1 Watt of power.

3. The optical communication system of claim 2, further comprising a controller configured to control the at least two laser diodes such that each laser diode provides ⅓ to ½ Watt of power.

4. The optical communication system of claim 3, wherein each of the first and second fiber pump laser systems is configured to provide at least 2 Watts of output power.

5. The optical communication system of claim 4, wherein each of the first and second fiber pump laser systems is configured to operate such that each provides less than 1 Watt of output power.

6. The optical communication system of claim 1, wherein each of the first and second fiber pump laser systems further comprises an input passive fiber disposed between the MM passive fiber and the active fiber, the MM passive fiber having a tapered free end with a mode field diameter (MFD) that matches that of an input end of the input passive fiber.

7. The optical communication system of claim 6, wherein each of the first and second fiber pump laser systems further includes an output SM passive fiber coupled to an output end of the active fiber and configured to output the respective first and second pump radiation.

8. The optical communication system of claim 6, wherein the MM passive fiber, the input passive fiber, and the active fiber are constructed from photonic crystal fiber.

9. The optical communication system of claim 1, wherein the first fiber pump laser system is configured to output the first pump radiation at a wavelength of about 978 nm and the second fiber pump laser system is configured to output the second pump laser radiation at a wavelength of about 983 nm.

10. The optical communication system of claim 1, wherein each of the first and second fiber pump laser systems includes N laser diodes.

11. The optical communication system of claim 1, further comprising N wavelength division multiplexing (WDM) couplers, each WDM coupler positioned between the at least one combiner-splitter element and a doped fiber amplifier of the N doped fiber amplifiers and configured to couple the input optical signal and the one portion of the N portions of pump laser radiation into an output that is provided to a doped fiber amplifier of the N doped fiber amplifiers.

12. A method for providing a fiber laser pump signal in an optical communication system, comprising:
providing first and second fiber pump laser systems, each of the first and second fiber pump laser systems including at least two laser diodes, an active fiber optically coupled to the at least two laser diodes, and a multimode (MM) passive fiber disposed between the at least two laser diodes and the active fiber;
generating single mode (SM) first and second pump laser radiation from the respective first and second fiber pump laser systems;
combining the SM first and second pump laser radiation to form a combined pump laser radiation;
splitting the combined pump laser radiation to form N portions of pump laser radiation, where N is at least four, and
directing an input optical signal to be amplified and each portion of pump laser radiation to a doped fiber amplifier, the doped fiber amplifier configured to receive the input optical signal and the portion of pump laser radiation and to amplify the input optical signal into an amplified optical signal.

13. The method of claim 12, further comprising controlling the at least two laser diodes such that each laser diode provides ⅓ to ½ Watt of power.

14. The method of claim 12, further comprising controlling each of the first and second fiber pump laser systems to provide less than 1 Watt of output power.

15. The method of claim 12, further comprising providing the MM passive fiber with a tapered free end with a mode field diameter (MFD) that matches that of an input end of an input passive fiber having an output end spliced to the active fiber.

16. The method of claim 15, further comprising providing the MM passive fiber, the active fiber, and the input passive fiber as photonic crystal fibers.

17. The method of claim 12, further comprising providing at least one combiner-splitter element configured to perform the combining and the splitting, the method further comprising coupling the SM first and second pump laser radiation generated by the respective first and second fiber pump laser systems to the at least one combiner-splitter.

18. A submersible fiber pump laser system for an erbium doped amplifier configured to amplify input optical signals in a fiber optic undersea communication system, comprising:
a multimode (MM) pig-tailed diode laser module that includes
N laser diodes enclosed in a housing, where N is at least two and the N laser diodes are operative to generate pump light at a first wavelength, and
an output MM fiber optically coupled to the N laser diodes and configured as a photonics crystal fiber with a tapered free end; and
a ytterbium-doped fiber amplifier configured to amplify the pump light and having a passive input end and a passive output end, the passive input end spliced to the tapered free end of the output MM fiber, the ytterbium-doped fiber amplifier operative to generate amplified pump light at a second wavelength that is longer than the first wavelength and is output from the passive output end.

19. An optical repeater containing at least four of the submersible fiber pump laser systems of claim 18.

20. The optical repeater of claim 19, wherein two of the four submersible fiber pump laser systems are configured to pump four doped fiber amplifiers optically coupled to input optical signals propagating in a first direction and the other two of the four fiber pump laser systems are configured to pump four doped fiber amplifiers optically coupled to input optical signals propagating in a second direction that is opposite the first direction.

21. An optical repeater, comprising:
an amplifier tray assembly having a surface configured with at least one recess dimensioned to receive a gain block module;
a plurality of fiber pump laser systems, each fiber pump laser system including a multimode (MM) pig-tailed diode laser module having
N laser diodes, where N is at least two and the N laser diodes are operative to generate pump light at a first wavelength, and
an output MM fiber optically coupled to the N laser diodes and configured as a photonics crystal fiber with a tapered free end; and
a ytterbium-doped fiber amplifier configured to amplify the pump light and having a passive input end and a passive output end, the passive input end spliced to the tapered free end of the output MM fiber, the amplifier operative to generate amplified pump light at a second wavelength that is longer than the first wavelength and is output from the passive output end; and
a laser tray assembly having a surface configured with a plurality of recesses, each recess dimensioned to receive a fiber pump laser system of the plurality of fiber pump laser systems.

22. The optical repeater of claim 21, further comprising at least one gain block module, that at last one gain block module including a plurality of gain block assemblies, each gain block assembly including an input, an output, and an erbium (Er) doped fiber disposed between the input and the output, the input optically coupled to the passive output end of at least one fiber pump laser system.

23. The optical repeater of claim 22, wherein the passive output end of the ytterbium-doped fiber amplifier is included in a SM delivery fiber and the surface of the laser tray assembly includes a plurality of channels dimensioned to receive at least one SM delivery fiber.

24. The optical repeater of claim 23, further comprising a fiber guide assembly attached at opposing end portions of the amplifier tray assembly, each fiber guide assembly including guide channels configured to couple to at least one of the plurality of channels and to the input of at least one gain block assembly of the plurality of gain block assemblies.

25. The optical repeater of claim 24, further comprising a thermally conductive ceramic member disposed between the amplifier tray assembly and the laser tray assembly.

26. The optical repeater of claim 25, further comprising a printed circuit board having opposing outer faces and configured such that a plurality of photodetector diodes are disposed on one of the opposing outer faces and one of the opposing outer faces is disposed on the surface of the laser tray assembly.

27. The optical repeater of claim 26, wherein the amplifier tray assembly, the laser tray assembly, the plurality of fiber pump laser systems, the at least one gain block module, the fiber guide assembly, the thermally conductive ceramic member, and the printed circuit board form at least a portion of an erbium doped fiber amplifier (EDFA) module, and the optical repeater is configured to include three EDFA modules arranged in a triangular configuration.

28. The optical repeater of claim 27, wherein each EDFA module includes four fiber pump laser systems and a gain block module having eight gain block assemblies, the EDFA module configured such that two of the four fiber pump laser systems pump four of the eight gain block assemblies and the other two of the four fiber pump laser systems pump the other four of the eight gain block assemblies.

29. The optical repeater of claim 28, further comprising at least one input configured to accommodate at least 12 fiber pairs of input signal optical fiber.

30. The optical repeater of claim 29, having a gain of at least 14 dB and an output power of +17 dB.
